(19) United States
(12) Patent Application Publication
(10) Pub. No.: US 2007/0244589 A1
(43) Pub. Date: Oct. 18, 2007

(54) DEMAND PREDICTION METHOD, DEMAND PREDICTION APPARATUS, AND COMPUTER-READABLE RECORDING MEDIUM

(76) Inventors: Takenori OKU, Saitama (JP); Makiko Watanabe, Kanagawa (JP); Yasuyuki Kimura, Kanagawa (JP); Fumihiro Nagano, Kanagawa (JP); Seiji Adachi, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/736,861

(22) Filed: Apr. 18, 2007

(30) Foreign Application Priority Data
Apr. 18, 2006 (JP) 2006-114818
Apr. 25, 2006 (JP) 2006-121155
Apr. 25, 2006 (JP) 2006-121156

(51) Int. Cl. G06F 19/00

(52) U.S. Cl. 700/97; 705/10

(57) ABSTRACT

A demand prediction apparatus connected to an order reception record storage unit for storing an order reception record of a product and an association information storage unit for storing association information associating products with each other, first acquires identification information of a product for which demand prediction is to be performed. The demand prediction apparatus specifies a product associated with the product having the acquired identification information based on the association information stored in the association information storage unit, and acquires an order reception record of the specified product from the order reception record storage unit. The demand prediction apparatus derives a demand prediction function that is fitted to the order reception record, by using the acquired order reception record. Then, the demand prediction apparatus calculates a predicted value of demand for the product for which demand prediction is performed, by using the derived demand prediction function, and outputs it.

### BACKGROUND OF THE INVENTION

1. Field of the Invention

The present invention relates to a demand prediction method, demand prediction apparatus for predicting demand for a product, and computer-readable recording medium.

2. Description of the Related Art

Appropriate goods inventory control is necessary for selling goods to customers. Goods include not only final goods, but consumable goods used for final goods, etc., spare parts in case of failure, etc. Appropriate goods inventory control enables reduction in inventory loss due to excess inventory and in opportunity loss due to shortage of goods available.

Accurate demand prediction is required to conduct appropriate goods inventory control. For example, multiple regression analysis is used for demand prediction. Multiple regression analysis analyzes past performance and generates a prediction relation. However, if the prediction relation once generated is used for long, the predicted value and the actual value will differ greatly.

To reduce the range of such an error, for example, Unexamined Japanese Patent Application KOKAI Publication No. 2000-339543 proposes a sales prediction method for predicting sales in consideration of changing factors. This sales prediction method first calculates the average value of shifts in sales records of a product, whose demand is to be predicted. Then, the method calculates a predicted amount of variation in the number of product lots to sell, based on changing factors that are considered to affect the number of lots to sell on the day for which demand prediction is performed. Further, the method corrects the average value of shifts based on the predicted amount of variation to calculate a predicted volume of sales.

Demand prediction based on an average amount of shifts would produce a large prediction error because of time lags. Therefore, goods need to be stocked a bit more than predicted. Further, this prediction method needs to specify the changing factors that are considered to affect the number of lots to sell on the day for which demand prediction is performed. However, variation in the number of lots to sell comes from various factors, and changing factors are therefore difficult to specify.

Unexamined Japanese Patent Application KOKAI Publication No. 2004-234471 proposes another demand prediction method. According to the technique disclosed in this document, a computer applies a growth model to the transition of an accumulated volume of orders received and derives a trend function that indicates a trend in the order reception records. Next, the computer calculates the transition of the difference between the order reception records and the trend function. Then, the computer calculates synchronicity degree of the periodicity of the transition of the difference by using a periodogram. Next, the computer determines the periodicity based on the calculated synchronicity degree, and applies a second-order Sin model constituted by a quadratic function and a trigonometric function to the transition of the difference between the order reception records and the trend function to calculate a periodic function. Then, the computer generates a new demand prediction function by combining the trend function and the periodic function, and predicts the demand by using this demand prediction function.

The techniques disclosed in Unexamined Japanese Patent Application KOKAI Publication No. 2000-339543 and Unexamined Japanese Patent Application KOKAI Publication No. 2004-234471 indicated above predict demand based on the past sales records. Therefore, these methods cannot predict demand for a product used for a new model of a product (new model) for which no sales record has been accumulated.

Further, there are many schemes in the demand prediction method for predicting the volume of future orders from the past order reception records, such as the techniques disclosed in Unexamined Japanese Patent Application KOKAI Publication No. 2000-339543 and Unexamined Japanese Patent Application KOKAI Publication No. 2004-234471. Therefore, it is necessary to adopt a demand prediction method suitable for the product to be predicted, from a plurality of demand prediction methods. It is therefore critical which demand prediction method to select.

Here, a method that uses a contribution ratio is known as a method for selecting a demand prediction method. A contribution ratio is represented by (variance of predicted values)/(variance of actual measurement values), and the closer to 1 this value is, the higher the degree of coincidence between the prediction and the actual measurement. However, it has been mathematically proven that as the order of the formula used in a demand prediction method becomes higher, the contribution ratio becomes higher (e.g., Hitoshi Kume, Yoshinori Iizuka, “Regression Analysis”, Iwanami Shoten, October 1987, pp. 153-155). Therefore, in a case where demand prediction relations having different orders from each other are used for demand prediction, one demand prediction relation is not more suitable for demand prediction for a given product than the other simply because its contribution ratio is higher.

Meanwhile, there is known a freedom-degree-adjusted contribution ratio, which is created for the purpose of adjusting the difference in order. A freedom-degree-adjusted contribution ratio indicates a degree of coincidence within the range of a period in which the data used for selecting a demand prediction relation are collected, but does not indicate a future degree of coincidence. Hence, even if the freedom-degree-adjusted contribution ratio is high, the accuracy of demand prediction does not necessarily improve.

### SUMMARY OF THE INVENTION

The present invention was made to solve the above-described problem, and an object of the present invention is to provide a demand prediction method and a demand prediction apparatus which accurately predict demand for a product for which no or few orders has/have been received.

Another object of the present invention is to provide a demand prediction method and a demand prediction apparatus which accurately predict demand for a new product.

Yet another object of the present invention is to provide a demand prediction method and a demand prediction apparatus which select one from a plurality of demand prediction relations that is suitable for each product and accurately predict demand for the product based on the selected demand prediction relation.

To achieve the above objects, a demand prediction apparatus according to a first aspect of the present invention is a demand prediction apparatus connected to an order reception record data storage unit for storing an order reception record of a product, and an association information storage unit for storing association information for associating products with each other, ad comprises:

a product identification information acquiring unit which acquires identification information of a product, for which demand prediction is to be performed;

an associated product specifying unit which specifies at least one associated product which is associated with the product having the identification information acquired by the product identification information acquiring unit, based on the association information stored in the association information storage unit, so that demand for the product is predicted;

a predicted value calculating unit which acquires an order reception record of the associated product specified by the associated product specifying unit from the order reception record data storage unit, and calculates a predicted value of the demand based on the acquired order reception record; and

a predicted value output unit which output the predicted value calculated by the predicted value calculating unit.

The association information storage unit may store product history information indicating from what product a product is changed, as the association information,

the associated product specifying unit may
comprise a product history information acquiring unit which acquires product history information regarding a product having identification information acquired by the product identification information acquiring unit from the association information storage unit, and
specify a product which is indicated by the product history information acquired by the product history information acquiring unit and from which the product having the identification information acquired by the product identification information acquiring unit has been changed, as an associated product, and

the predicted value calculating unit may
comprise: a record acquiring unit which acquires an order reception record of the associated product specified by the associated product specifying unit and an order reception record of the product having the identification information acquired by the product identification information acquiring unit from the order reception record data storage unit; and
a demand prediction function deriving unit which derives a demand prediction function for predicting demand for the product, by using the order reception records acquired by the record acquiring unit, and
calculate a predicted value of the demand for the product, by using the demand prediction function derived by the demand prediction function deriving unit.

The association information storage unit may store, as the product history information, identification information of each of past products from one of which to another of which a product has been changed, in association with identification information of the product, and

the product history information acquiring unit may acquire all pieces of ID information that are associated with identification information acquired by the product identification information acquiring unit, from the association information storage unit, as product history information.

The association information storage unit may store, in association with identification information of a product, identification information of at least one product, which is in an older generation than the product,

the product history information acquiring unit may
comprise a unit which performs a process of acquiring identification information associated with identification information acquired by the product identification information acquiring unit based on the association information stored in the association information storage unit, and an older generation product acquiring process of acquiring identification information of a product which is in an older generation than a product having the identification information thusly acquired, based on the association information stored in the association information storage unit, and
repeat the older generation product acquiring process until it is no more possible to acquire identification of any product that is in an order generation, and acquire all pieces of acquired identification information, as product history information.

In a case where order reception records of a plurality of products acquired by the record acquiring unit include order reception records of a same period, the record acquiring unit may acquire a record obtained by adding these order reception records of the same period, as an order reception record of this period.

The association information storage unit may store information that associates a product with an apparatus that uses this product, as association information,

the demand prediction apparatus may further comprise an apparatus attribute data storage unit which stores, for each apparatus, attribute data regarding the apparatus,

the associated product specifying unit may
comprise: an apparatus specifying unit which specifies an apparatus that uses a product having identification information acquired by the product identification information acquiring unit, based on the association information stored in the association information storage unit; and
a similar apparatus specifying unit which specifies a similar apparatus which is similar to the apparatus specified by the apparatus specifying unit, based on the attribute data stored in the apparatus attribute data storage unit, and
specify a product used by the similar apparatus specified by the similar apparatus specifying unit based on the association information stored in the association information storage unit, and specify this specified product as an associated product in a case where identification information of this specified product coincides with the identification information acquired by the product identification information acquiring unit, and

the predicted value calculating unit may
comprise a record acquiring unit which acquires an initial order reception record of the associated product specified by the associated product specifying unit from the order reception record data storage unit, and
calculate a predicted value of demand for the product having the identification information acquired by the product identification information, by using the initial order reception record acquired by the record acquiring unit.

The attribute data may include data regarding an initially planned sales quantity of an apparatus, and

the predicted value calculating unit may
comprises an initially planned sales quantity acquiring unit which acquires an initially planned sales quantity of each of the apparatus specified by the apparatus specifying unit and the similar apparatus, from the attribute data stored in the apparatus attribute data storage unit, and
calculate a value obtained by multiplying the initial order reception record acquired by the record acquiring unit by a rate of the initially planned sales quantity of the apparatus specified by the apparatus specifying unit to the initially planned sales quantity of the similar apparatus, as a predicted value.

The similar apparatus specifying unit may calculate a Euclidean distance between the apparatus specified by the apparatus specifying unit and each of a plurality of other apparatuses by using the attribute data of both the apparatuses as explaining variables, and specify any of the plurality of other apparatuses, whose calculated Euclidean distance is smallest, as the similar apparatus.

The similar apparatus specifying unit may normalize the explaining variables, and calculate the Euclidean distance by using the normalized explaining variables.

The similar apparatus specifying unit may perform cluster analysis between the apparatus specified by the apparatus specifying unit and each of a plurality of other apparatuses by using the attribute data of both the apparatuses as explaining variables, and specify any of the plurality of other apparatuses that is included in a smallest cluster that includes the apparatus specified by the apparatus specifying unit, as the similar apparatus.

The attribute data may include data regarding specifications of an apparatus, data regarding an assumed user of the apparatus, and data regarding maintenance of the apparatus, and

the similar apparatus specifying unit may use at least one of the data regarding specification of an apparatus, the data regarding an assumed user of the apparatus, and the data regarding maintenance of the apparatus, which are included in the attribute data, as an explaining variable.

A demand prediction apparatus according to a second aspect of the present invention is a demand prediction apparatus connected to an order reception record data storage unit for storing an order reception record of a product, comprising:

a product identification information acquiring unit which acquires identification information of a product for which demand prediction is to be performed;

an order reception record acquiring unit which acquires order reception records of the product having the identification information acquired by the product identification information acquiring unit from the order reception record data storage unit;

a provisional demand prediction function deriving unit which, by using a plurality of methods, derives provisional demand prediction functions that are fitted to those order reception records, among the order reception records acquired by the order reception record acquiring unit, that are dated in a provisional function deriving period which does not include a predetermined evaluation period which is immediately before a present time,

a method specifying unit which calculates predicted values of order reception records of the evaluation period by using the provisional demand prediction functions derived by the provisional demand prediction function deriving unit, and specifies a method for deriving a demand prediction function based on the calculated predicted values and order reception records of the evaluation period stored in the order reception record data storage unit;

a demand prediction function deriving unit which derives a demand prediction function which is fitted to the order reception records acquired by the order reception record acquiring unit, by using the method specified by the method specifying unit;

a predicted value calculating unit which calculate a predicted value of demand for a product by using the demand prediction function derived by the demand prediction function deriving unit; and

a predicted value output unit which outputs the predicted value calculated by the predicted value calculating unit.

The method specifying unit may calculate, for each of a plurality of provisional demand prediction functions derived by the provisional demand prediction function deriving unit, a difference between the predicted value of the evaluation period calculated by using the provisional demand prediction function and the order reception record of the evaluation period stored in the order reception record data storage unit, specify a provisional demand prediction function whose calculated difference is smallest, and specify a method used for deriving the specified provisional demand prediction function as a method for deriving a demand prediction function.

The provisional demand prediction function deriving unit may derive the provisional demand prediction functions by using a plurality of methods, for each of a plurality of provisional function deriving periods each of which does not include an evaluation period different in length from other evaluation periods which are not included in the others of the plurality of provisional function deriving periods respectively, and

the method specifying unit may perform a process of calculating, for each of the provisional function deriving periods, a difference between a predicted value of a corresponding one of the evaluation periods calculated by using each of the provisional demand prediction functions derived for the provisional function deriving period concerned and the order reception record of that evaluation period, and counting up a score of the method that derives the provisional demand prediction function whose calculated difference is smallest, for each of the provisional function deriving periods, and specify the method whose score is counted up most often, as a method for deriving a demand prediction function.

In a case where there are a plurality of provisional demand prediction functions whose calculated differences between a predicted value calculated by using each of these provisional demand prediction functions and the order reception record acquired from the order reception record data storage unit are smallest at a same time, the method specifying unit may specify a method whose order is lowest of the methods used for deriving these plurality of provisional demand prediction functions, as a method for deriving a demand prediction function.

In a case where there are a plurality of methods whose scores are counted up most often at a same time, the method specifying unit may specify a method whose order is lowest of these methods, as a method for deriving a demand prediction function.

A demand prediction method according to a third aspect of the present invention is a demand prediction method for a demand prediction apparatus connected to an order reception record data storage unit for storing an order reception record of a product and an association information storage unit for storing association information for associating products with each other, and comprises:

acquiring identification information of a product for which demand prediction is to be performed;

specifying at least one associated product which is associated with the product having the acquired identification information based on the association information stored in the association information storage unit, so that demand prediction for the product having the acquired identification information is performed;

acquiring an order reception record of the specified associated product from the order reception record data storage unit, and calculating a predicted value of demand based on the acquired order reception record; and

outputting the calculated predicted value.

A demand prediction method according to a fourth aspect of the present invention is a demand prediction method for a demand prediction apparatus connected to an order reception record data storage unit for storing an order reception record of a product, and comprises:

acquiring identification information of a product for which demand prediction is to be performed;

acquiring order reception records of the product having the acquired identification information from the order reception record data storage unit;

by using a plurality of methods, deriving provisional demand prediction functions which are fitted to those order reception records, among the acquired order reception records, that are dated in a provisional function deriving period which does not include a predetermined evaluation period which is immediately before a present time;

calculating a predicted value of the order reception record of the evaluation period by using each of the derived provisional demand prediction functions, and specifying a method for deriving a demand prediction function based on the calculated predicted values and the order reception record of the evaluation period stored in the order reception record data storage unit;

deriving a demand prediction function which is fitted to the order reception records, by using the specified method;

calculating a predicted value of demand for the product by using the derived demand prediction function; and

outputting the calculated predicted value.

A computer-readable recording medium according to a fifth aspect of the present invention stores a program for controlling a computer connected to an order reception record data storage unit for storing an order reception record of a product and an association information storage unit for storing association information for associating products with each other, to function as:

a product identification information acquiring unit which acquires identification information of a product, for which demand prediction is to be performed;

an associated product specifying unit which specifies at least one associated product which is associated with the product having the identification information acquired by the product identification information acquiring unit, based on the association information stored in the association information storage unit, so that demand for the product is predicted;

a predicted value calculating unit which acquires an order reception record of the associated product specified by the associated product specifying unit from the order reception record data storage unit, and calculates a predicted value of the demand based on the acquired order reception record; and

a predicted value output unit which outputs the predicted value calculated by the predicted value calculating unit.

A computer-readable recording medium according to a sixth aspect of the present invention stores a program for controlling a computer connected to an order reception record data storage unit for storing an order reception record of a product, to function as:

a product identification information acquiring unit which acquires identification information of a product for which demand prediction is to be performed;

an order reception record acquiring unit which acquires order reception records of the product having the identification information acquired by the product identification information acquiring unit from the order reception record data storage unit;

a provisional demand prediction function deriving unit which, by using a plurality of methods, derives provisional demand prediction functions that are fitted to those order reception records, among the order reception records acquired by the order reception record acquiring unit, that are dated in a provisional function deriving period which does not include a predetermined evaluation period which is immediately before a present time,

a method specifying unit which calculates predicted values of order reception records of the evaluation period by using the provisional demand prediction functions derived by the provisional demand prediction function deriving unit, and specifies a method for deriving a demand prediction function based on the calculated predicted values and order reception records of the evaluation period stored in the order reception record data storage unit;

a demand prediction function deriving unit which derives a demand prediction function which is fitted to the order reception records acquired by the order reception record acquiring unit, by using the method specified by the method specifying unit;

a predicted value calculating unit which calculates a predicted value of demand for the product by using the demand prediction function derived by the demand prediction function deriving unit; and

a predicted value output unit which outputs the predicted value calculated by the predicted value calculating unit.

### BRIEF DESCRIPTION OF THE DRAWINGS

These objects and other objects and advantages of the present invention will become more apparent upon reading of the following detailed description and the accompanying drawings in which:

FIG. 1 is a schematic diagram of a demand prediction apparatus according to a first embodiment;

FIG. 2 is a block diagram showing the structure of an order reception system;

FIG. 3 is block diagram showing the structure of a managing computer;

FIG. 4 is a diagram for explaining data stored in a transitional data storage unit;

FIG. 5 is a diagram for explaining data stored in an order reception record data storage unit;

FIG. 6 is a flowchart for explaining the procedures of a demand prediction process according to the first embodiment;

FIG. 7 is a flowchart for explaining the procedures of a demand prediction function deriving process;

FIG. 8 is a diagram showing a specific example of order reception records;

FIGS. 9A to 9C are diagrams showing relationships between order reception records and trend curves;

FIG. 10 is a diagram specifically showing determining a method optimum for deriving a demand prediction function based on errors of provisional demand prediction functions;

FIG. 11 is a diagram showing an example of a demand predicted values display screen according to the first embodiment;

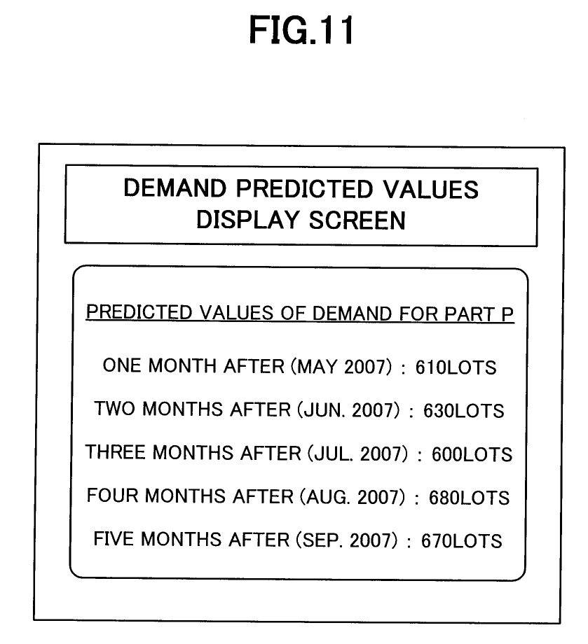

FIG. 12 is a diagram showing a specific example of order reception records of a part subjected to design change;

FIG. 13 is a diagram showing order reception records of a part subjected to design change, and a demand prediction curve;

FIG. 14 is a diagram for explaining data stored in the transitional data storage unit;

FIG. 15 is a flowchart for explaining the procedures of a modified example of the demand prediction function deriving process;

FIG. 16 is a diagram specifically showing determining a method optimum for deriving a demand prediction function based on errors of provisional demand prediction functions;

FIG. 17 is a diagram specifically showing adopting a method with lower order, in a case where there are a plurality of methods that achieve the largest number of times of the smallest error;

FIG. 18 is a schematic diagram of a demand prediction apparatus according to a second embodiment;

FIG. 19 is a diagram for explaining data stored in a model attribute data storage unit;

FIG. 20 is a diagram for explaining data stored in a part data storage unit;

FIG. 21 is a flowchart for explaining the procedures of a new model demand prediction process according to the second embodiment;

FIG. 22 is a diagram showing a Euclidean distance between each same field model and a new model;

FIG. 23 is a diagram showing an example of a demand predicted values display screen according to the second embodiment; and

FIG. 24 is a diagram showing another example of the process of calculating similarity degrees and specifying a similar model.

### DETAILED DESCRIPTION OF THE PREFERRED EMBODIMENTS

A demand prediction method and a demand prediction apparatus according to the embodiments of the present invention will be explained below with reference to the drawings.

The demand prediction method and the demand prediction apparatus according to the embodiments predict demand for a part of a product provided to customers, based on the orders received in the past. Here, the part means one that is used in a product and provided for free for replenishment or replacement due to wastage, failure, etc. This part needs to be replenished or replaced to maintain the function f the product, and may not only be a single-body part, but a unit constituted by some parts combined.

### First Embodiment

A demand prediction method and a demand prediction apparatus according to the present embodiment predict demand for a part which has undergone design change plural times.

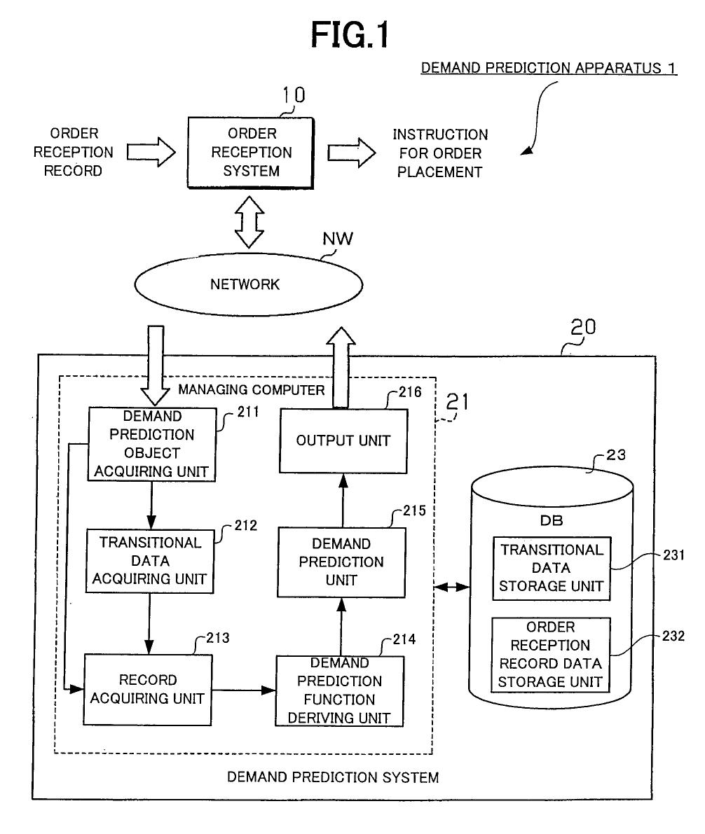

The demand prediction apparatus 1 according to the present embodiment comprises an order reception system 10 and a demand prediction system 20, as shown in FIG. 1.

The order reception system 10 receives an order reception record at a sales base or at a servicing base. The order reception system 10 places an order for a part to a production department or a purchase department. The order reception system 10 is installed in, for example, a department that purchases, stores, and manages a part.

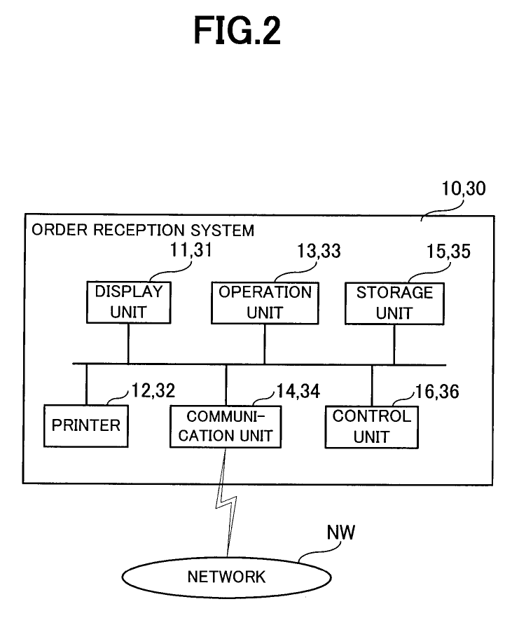

As shown in FIG. 2, the order reception system 10 comprises a display unit 11, a printer 12, an operation unit 13, a communication unit 14, a control unit 15, and a storage unit 16.

The display unit 11 comprises an LCD (Liquid Crystal Display), a CRT (Cathode Ray Tube), or the like, and displays a screen from which a user enters an order reception record, a result of demand prediction output from the demand prediction system 20, etc.

The printer 12 prints various data, for example, a result of demand prediction output from the demand prediction system 20.

The operation unit 13 comprises a keyboard, a mouse, etc., and receives inputs of various data and instructions.

The communication unit 14 comprises communication devices such as an NIC (Network Interface Card), a router, a modem, etc., and exchanges data and commands with the demand prediction system 20.

The storage unit 15 comprises a RAM (Random Access Memory), a ROM (Read Only Memory), a hard disk device, etc., and stores operation programs of the control unit 16 and various data.

The control unit 16 comprises a CPU (Central Processing Unit) or the like, and controls the display unit 11, the printer 12, the operation unit 13, the communication unit 14, and the storage unit 15 by executing operation programs stored in the storage unit 15.

For example, the control unit 16 controls the display unit 11 to display a screen from which a user inputs an order reception record, a result of demand prediction output from the demand prediction system 20, etc. The control unit 16 controls the printer 12 to print a result of demand prediction output from the demand prediction system 20, etc. Further, via the communication unit 14, the control unit 16 sends data identifying a part that requires demand prediction, past order reception records, a demand prediction start command, etc. to the demand prediction system 20, receives a result of demand prediction from the demand prediction system 20, and outputs it to the display unit 11 or the printer 12 and stores it in the storage unit 15.

The demand prediction system 20 of FIG. 1 predicts demand for a part, and comprises a managing computer 21, and a database 23 connected to the managing computer 21 through a network. The database 23 comprises a transitional data storage unit 231 and an order reception record data storage unit 232.

In terms of functions, the managing computer 21 comprises a demand prediction object acquiring unit 211, a transitional data acquiring unit 212, a record acquiring unit 213, a demand prediction function deriving unit 214, a demand prediction unit 215, and an output unit 216.

The demand prediction object acquiring unit 211 acquires identification (ID) information of a part for which demand prediction is to be performed, from the order reception system 10 through the network NW.

The transitional data acquiring unit 212 determines whether or not the part having the ID information acquired by the demand prediction object acquiring unit 211 is a part that has undergone specification change in the past. Then, when it is determined that it is a part that has undergone specification change in the past, the transitional data acquiring unit 212 acquires ID information of the parts before the specification change.

The record acquiring unit 213 acquires order reception record data of the part that has the ID information acquired by the demand prediction object acquiring unit 211 and the ID information acquired by the transitional data acquiring unit 212, from the order reception record data storage unit 232.

The demand prediction function deriving unit 214 derives a demand prediction function for predicting demand, based on the record data acquired by the record acquiring unit 213.

The demand prediction unit 215 predicts demand for the part by using the demand prediction function derived by the demand prediction function deriving unit 214.

The output unit 216 outputs the data of the demand prediction for the part that is obtained by the demand prediction unit 215 to the order reception system 10 through the network NW.

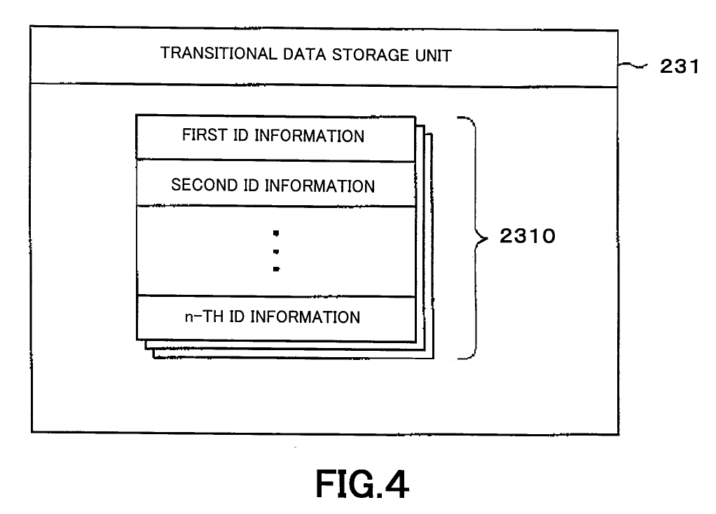

As shown in FIG. 4, the transitional data storage unit 231 stores transitional data 2130 that shows the history of design changes made on a part that has undergone design change. Transitional data 2310 is generated when design change is first made to a part. Early transitional data 2310 includes ID information of the part before and after the change. Then, after this, each time the part is changed, ID information of the part after the change is added to the transitional data 2310.

Therefore, in a case where transitional data 2310 includes n pieces of part ID information, the part having the ID information which is recorded at the top of the transitional data 2310 has undergone changes (n−1) times.

Specifically, transitional data 2310 includes first ID information to n-th (n being a natural number equal to or larger than 2) ID information.

The first ID information is the original ID information of the part subjected to design change (ID information before design change). The second ID information is ID information that is given for the second time (or given after the first design change) to the part. Likewise, the n-th part ID information is ID information that is given for the n-th time to the part subjected to design change. The n-th ID information enables to specify the latest part. ID information is, for example, a part-unique number.

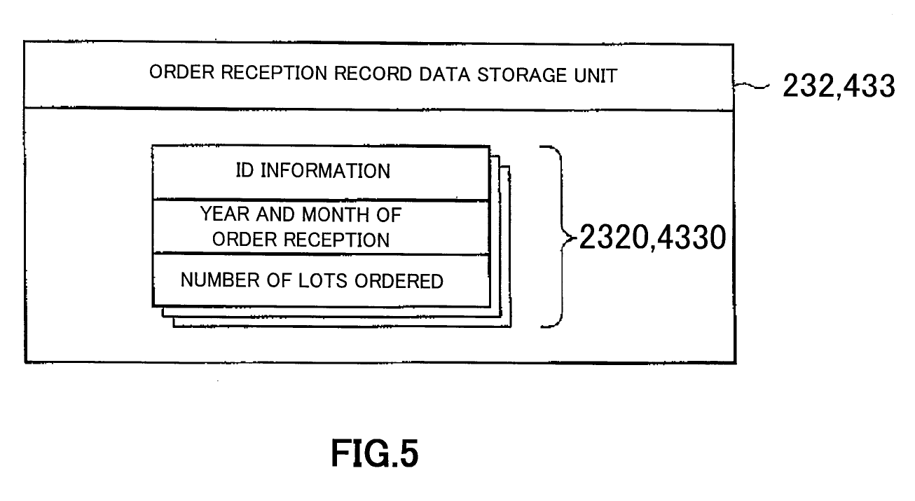

The order reception record data storage unit 232 stores order reception record data 2320 as shown in FIG. 5. Order reception record data 2320 is prepared for each part, and includes ID information of the part, information indicating the year and month when an order for the part is received, and information indicating the number of lots ordered. Order reception record data 2320 is generated by the managing computer 21 based on a monthly order reception record output from the order reception system 10.

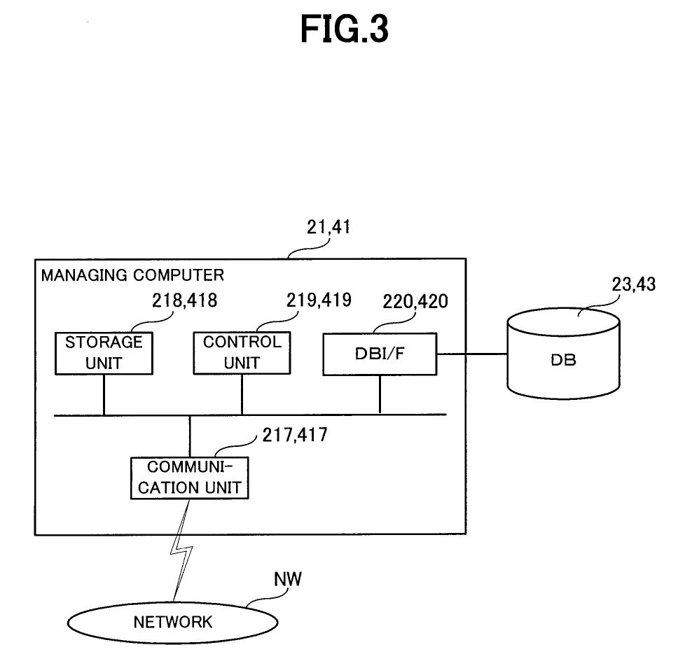

As shown in FIG. 3, the demand prediction system 20 comprises the managing computer 21, which physically comprises a communication unit 217, a storage unit 218, a control unit 219, and a DB (Data Base) I/F (Inter Face) 220, and the database 23.

The communication unit 217 comprises communication devices such as an NIC (Network Interface Card), a router, a mode, etc.

The storage unit 218 comprises a RAM, a ROM, a hard disk device, etc., and stores various information, operation programs of the control unit 219, etc.

The control unit 219 comprises a CPU or the like, and performs various calculations by executing the operation programs stored in the storage unit 218. Further, the control unit 219 exchanges data with the order reception system 10 through the communication unit 217.

The DB I/F 220 intermediates in the data exchange between the DB 23 and the control unit 219.

The demand prediction object acquiring unit 211 and the output unit 216 shown in FIG. 1 physically comprise the control unit 219 and the communication unit 217.

The transitional data acquiring unit 212 and the record acquiring unit 213 physically comprise the control unit 219 and the DB I/F 220.

The demand prediction function deriving unit 214 and the demand prediction unit 215 physically comprise the control unit 219 and the storage unit 218.

Next, the procedures by which the demand prediction system 20 predicts demand for a part will be explained.

First, as a premise, an order reception staff inputs order reception data acquired through daily order reception activities to the order reception system 10 through, for example, the operation unit 13. The control unit 16 of the order reception system 10 stores the data in the storage unit 15. The control unit 16 adds up the order reception record data stored in the storage unit 15 part by part at a predetermined timing, for example, at midnight on the last day of a month, etc. to generate monthly order reception record data 2320 part by part. The control unit 16 supplies the generated order reception record data 2320 to the demand prediction system 20 from the communication unit 14 through the network NW. The control unit 19 of the demand prediction system 20 receives the supplied data through the communication unit 217, and stores it in the order reception record data storage unit 232 in the database 23 through the DB I/F 220.

When there is a switch of a part from an old model to a new model, due to specification changes or the like, the order reception staff inputs information regarding the switch to the order reception system 10. If it is the first change, the order reception system 10 generates transitional data 2310 which includes the ID information of the part before the change as the first ID information, and ID information of the part after the change as the second ID information, and sends the generated data to the transitional data storage unit 231. The transitional data storage unit 231 stores the transitional data 2310 sent thereto. If the change is the second one or one thereafter, the order reception system 10 associates the ID information before the change and the ID information after the change and sends them to the transitional data storage unit 231. The transitional data storage unit 231 adds the ID information after the change to the tail of transitional data 2310 whose latest ID information is identical with the ID information before the change.

Next, when it becomes necessary to perform demand prediction for a given part, a user operates the operation unit 13 of the order reception system 10 and inputs an instruction for performing demand prediction for the part and ID information that specifies the objective part. In response to the input instruction, the control unit 16 sends a demand prediction start command from the communication unit 14 to the demand prediction system 20 through the network NW.

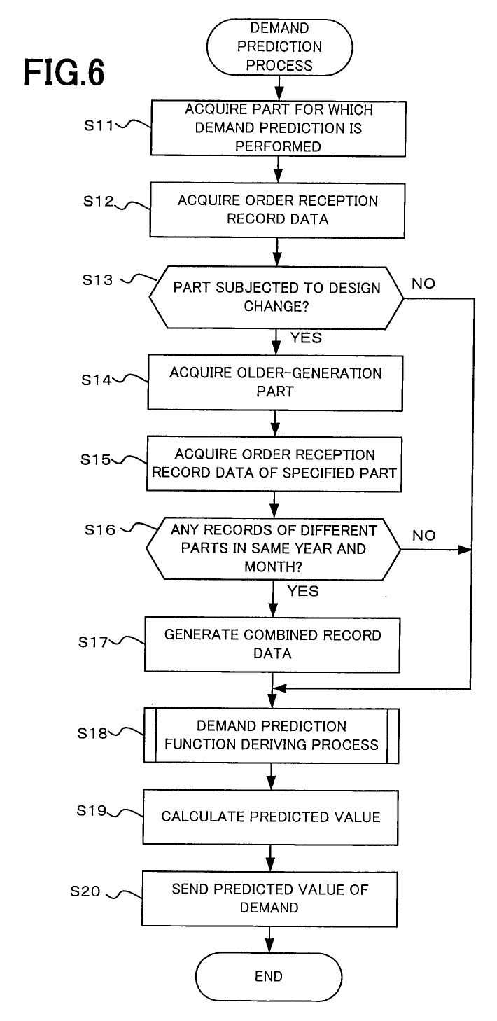

The control unit 219 of the demand prediction system 20 receives the demand prediction start command through the communication unit 217. In response to the demand prediction start command, the control unit 219 starts a demand prediction process shown in FIG. 6, if possible.

When the process is started, the control unit 219 requests the ID information of the part for which demand prediction is to be performed, from the order reception system 10 through the network NW. In response to this request, the order reception system 10 sends the input ID information to the demand prediction system 20. The control unit 219 of the demand prediction system 20 acquires this ID information through the communication unit 217 (step S11). Thus, the function of the demand prediction object acquiring unit 211 is realized.

Next, the control unit 219 acquires order reception record data 2320 that includes the ID information acquired at step S11 from the order reception record data storage unit 232 (step S12).

Next, the control unit 219 determines whether or not the objective part for which demand prediction is to be performed is a part that has been subjected to change (step S13). Specifically, the control unit 219 determines whether or not transitional data 2130 that includes the ID information acquired at step S11 is stored in the transitional data storage unit 231 (step S13).

In a case where it is determined that such data is stored (step S13; YES), which means that the objective part for which demand prediction is to be performed is a part that has been subjected to design change, the control unit 219 extracts ID information prior to the ID information acquired at step S11, from ID information included in the transitional data 2310 (step S14). On the other hand, in a case where it is determined that no such data is stored (step S13; NO), the process jumps to step S18 to be described later.

Next, the control unit 219 acquires order reception record data 2320 of the part specified by one piece or a plural pieces of ID information acquired at step S14 from the order reception record data storage unit 232 (step S15).

Next, the control unit 219 determines whether or not there are any records of orders for the part which has plural pieces of ID information within a single period (step S16). Specifically, the control unit 219 compares the year and month of order reception written in the order reception record data 2320 acquired at step S12 with those in the data 2320 acquired at step S15, and determines whether or not there are order reception record data 2320 that indicate the same year and month of order reception as each other.

In a case where there are order reception record data 2320 that indicate the same year and month of order reception (step S16; YES), the control unit 219 generates combined record data (step S17).

Specifically, the control unit 219 adds up the numbers of lots ordered which are indicated in the order reception record data 2320 that indicate the same year and month of order reception, and registers the sum as the number of lots ordered (combined record) in the year and month of order reception concerned. For example, in a case where the order reception record data 2320 acquired at step S12 indicates “April 2000” as the year and month of order reception and “30 lots” as the number of lots ordered, and the order reception record data 2320 acquired at step S15 indicates “April 2000” as the year and month of order reception and “50 lots” as the number of lots ordered, the number of lots ordered (combined record) that corresponds to the year and month of order reception “April 2000” is calculated as “80 lots”.

In a case where it is determined that there are no order reception record data 2320 that indicate the same year and month of order reception (step S16; NO), the process jumps to step S18, skipping calculation of combined record data.

Next, the control unit 219 derives a demand prediction function, based on the acquired order reception record data 2320 (step S18).

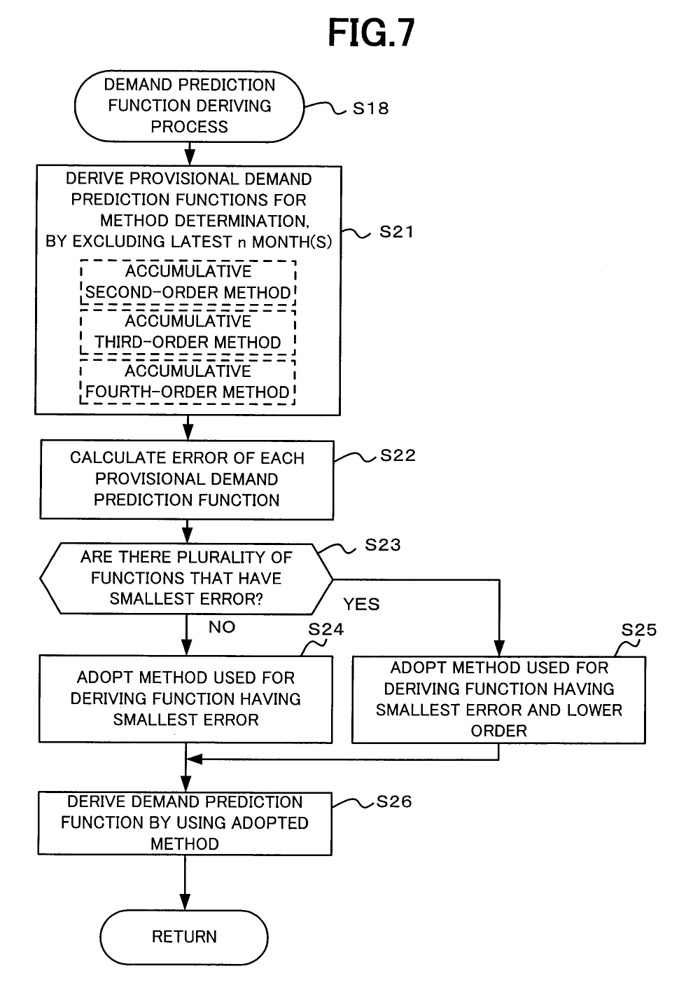

The details of the process (step 18) of deriving a demand prediction function will be explained based on FIG. 7.

First, by using a plurality of publicly known methods, the control unit 219 derives functions (provisional demand prediction functions) to be fitted to the order reception records indicated by the order reception record data 2320, of the acquired order reception record data 2320, that are dated within a provisional function deriving period which does not include the latest n months (evaluation period) (step S21).

Here, the process of deriving provisional demand prediction functions will be explained with a specific example. In this example, as the plurality of publicly known methods for deriving provisional demand prediction functions, an accumulative second-order method, an accumulative third-order method, and an accumulative fourth-order method will be used. The evaluation period is the latest three months.

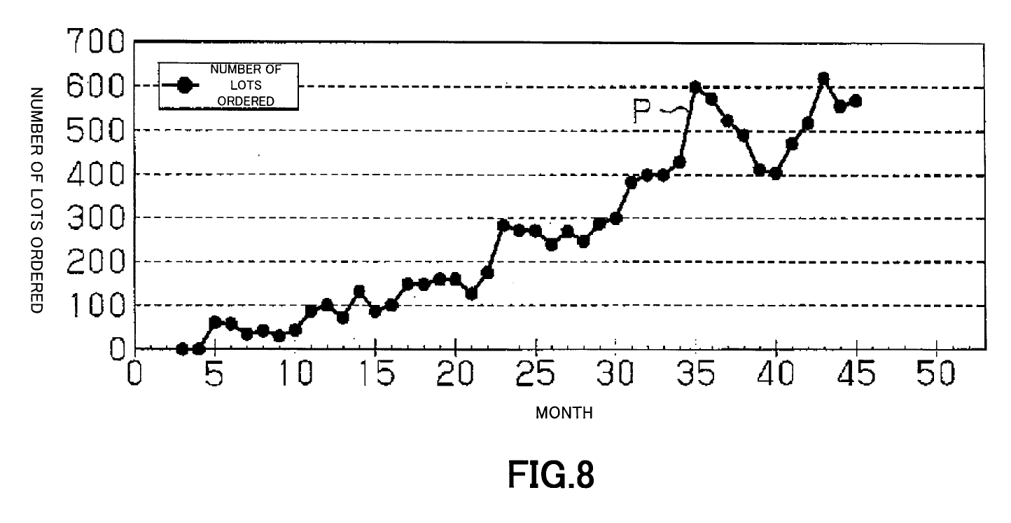

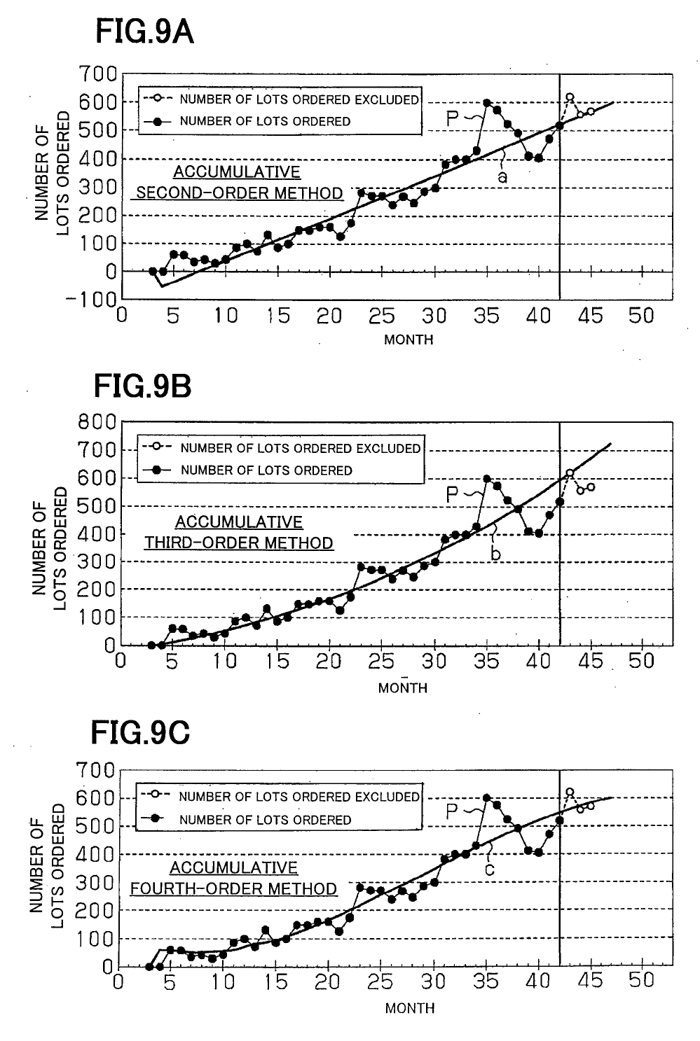

Further, as shown in FIG. 8, the order reception record data 2320 regarding the part for which provisional demand prediction functions are to be derived are available for consecutive forty-five months immediately before the current month. Therefore, the control unit 219 derives provisional demand prediction functions by using the order reception record data 2320, among those order reception record data 2320, that are of the forty-two months (provisional function deriving period) except the latest three months, with the use of the respective publicly known methods as shown in FIG. 9A to FIG. 9C. A trend curve “a” shown in FIG. 9A represents a provisional demand prediction function derived by the accumulative second-order method. A trend curve “b” shown in FIG. 9B and a trend function “c” shown in FIG. 9C represent a provisional demand prediction function derived by the accumulative three-order method and a provisional demand prediction function derived by the accumulative fourth-order method, respectively.

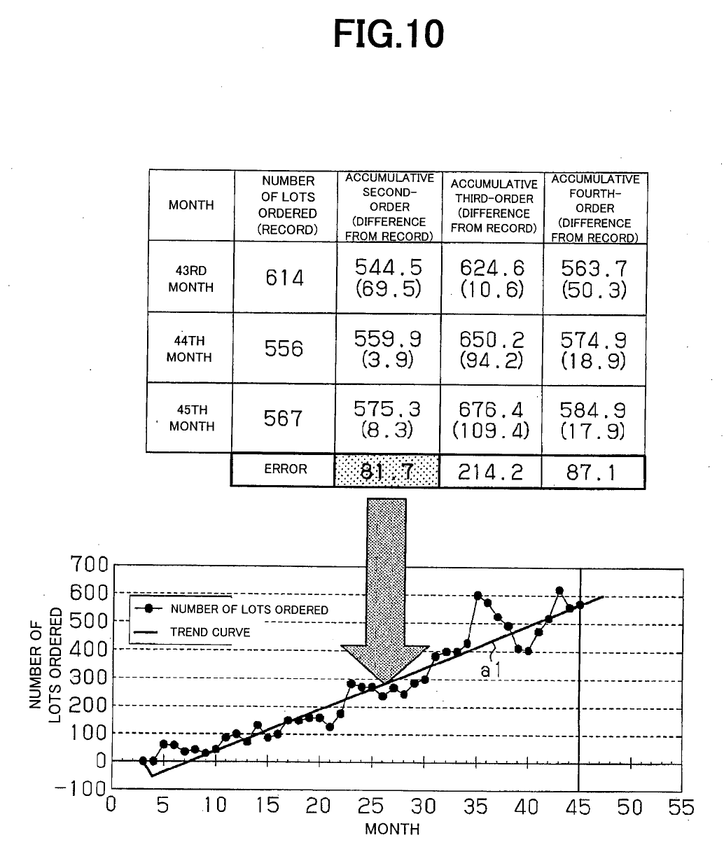

Next, the control unit 219 calculates errors of the respective provisional demand prediction functions derived at step S21 (step S22). Specifically, the control unit 219 calculates the difference between a predicted value calculated by each provisional demand prediction function and the actual measurement value, for the respective months in the evaluation period that are not used at step S21 for deriving the provisional demand prediction functions, and calculates the sum of the differences as the error. The process of calculating the errors of the provisional demand prediction functions shown in FIG. 9A to FIG. 9C will now be explained by using FIG. 10.

First, the control unit 219 calculates the number of lots to be ordered (predicted value) for the forty-third month by using the respective provisional demand prediction functions derived by the respective methods. Then, the control unit 219 calculates the difference between the predicted value of the forty-third month and the number of lots ordered (actual measurement value) in the forty-third month acquired from the order reception record data 2320, for each of the methods. Next, likewise for the forty-fourth month, the control unit 219 calculates the difference between the number of lots to be ordered (predicted value) calculated for the forty-fourth month and the number of lots ordered (actual measurement value) in the forth-fourth month acquired from the order reception record data 2320, for each of the methods. Furthermore, likewise for the forty-fifth month, the control unit 219 calculates the difference between the number of lots to be ordered (predicted value) calculated for the forty-fifth month and the number of lots ordered (actual measurement value) in the forty-fifth month acquired from the order reception record data 2320, for each of the methods. Then, the control unit 219 calculates the sum of the differences between the predicted value and the number of lots ordered (actual measurement value), which differences are calculated for each of the months (forty-third to forty-fifth months) that are not used for deriving the provisional demand prediction function, as the error of each provisional demand prediction function.

Returning to FIG. 7, next, the control unit 219 determines whether or not there are a plurality of provisional demand prediction functions whose errors calculated at step S22 are the smallest at the same time (step S23). In a case where it is determined that there is only one provisional demand prediction function whose calculated error is the smallest (step S23; NO), the control unit 219 adopts the method used for deriving the provisional demand prediction function whose error is the smallest (step S24), and proceeds to step S26. For example, in a case where the provisional demand prediction function derived by using the accumulative second-order method has the smallest error, the control unit 219 adopts the accumulative second-order method.

In a case where it is determined that there are a plurality of provisional demand prediction functions whose calculated errors are the smallest at the same time (step S23; YES), the control unit 219 adopts the method used for deriving the provisional demand prediction function whose error is the smallest and whose order is the lowest (step S25), and proceeds to step S26. For example, in a case where it is determined that the error of the provisional demand prediction function derived by the accumulative third-order method and the error of the provisional demand prediction function derived by the accumulative fourth-order method are equal to each other and the error of these provisional demand prediction functions is smaller than the error of the remaining provisional demand prediction function, the control unit 219 adopts the accumulative third-order method used for deriving the provisional demand prediction function whose order is lower

Next, the control unit 219 derives a demand prediction function, by applying the method adopted at step S24 or S25 to all the order reception record data 2320 regarding the part for which demand prediction is performed, including the data 2320 for the evaluation period (step S26). For example, in a case where the accumulative second-order method is adopted as shown in FIG. 10, the control unit 219 derives a demand prediction function by applying the accumulative second-order method to the order reception record data 2320 for up to the forty-fifth month. A trend curve “a1” of the function derived here is shown in FIG. 10.

Thus, the process of deriving the demand prediction function (step S18) is completed.

Returning to FIG. 6, the control unit 219 calculates the number of lots to be ordered in the coming month and the month next to it, etc., as predicted values, by using the demand prediction function derived at step S18 (step S19).

Next, the control unit 219 sends the predicted values calculated at step S19 to the order reception system 10 through the network NW (step S20).

The, the control unit 16 of the order reception system 10 displays the received predicted values on the display unit 11. Further, the control unit 16 prints the received predicted values by the printer 12. Thus, the demand prediction process is completed.

The user can instruct order placement for a product in appropriate lots based on the predictions displayed or printed by the order reception system 10.

### EXAMPLE

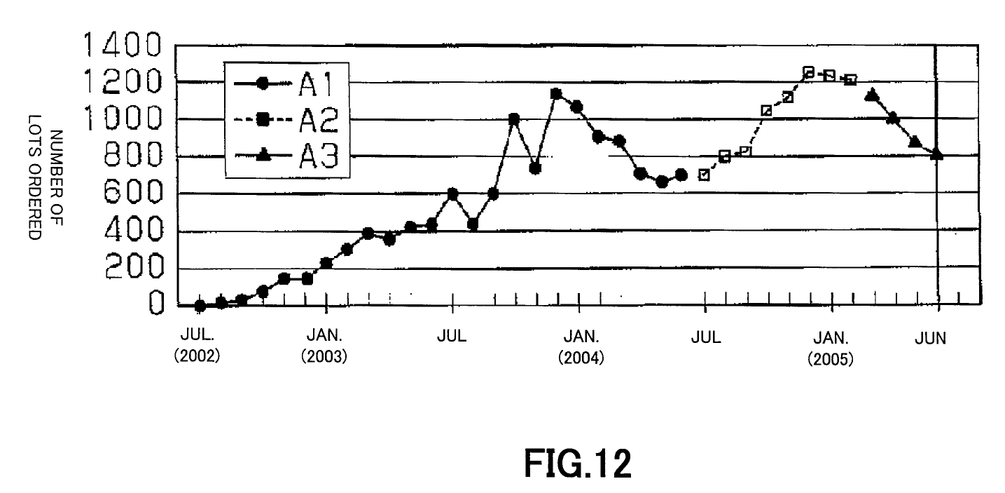

Next, the process of demand prediction for a part using specific numerals will be explained. The sales records of the part for which demand prediction is to be performed are as shown in FIG. 12. This part, for which demand prediction is to be performed, has been subjected to design changes twice, from a design having ID information “A1” before any design change to designs having ID information “A2” and “A3”.

Therefore, transitional data 2310 which includes “A1” as the first ID information, “A2” as the second ID information, and “A3” as the third ID information is stored inn the transitional data storage unit 231.

Further, it is assumed that the year and month of order reception written in order reception record data 2320 which indicate the ID information “A3” vary from “March to June in 2005”. The year and month of order reception written in order reception record data 2320 which indicate the ID information “A2” vary from “July 2004 to February 2005”. The year and month of order reception written in order reception record data 2320 which indicate the ID information “A1” vary from “July 2002 to June 2004”.

Under such conditions, when an instruction for demand prediction for the part having the ID information “A3” is given by the user to the order reception system 10 and a demand prediction start command is sent from the order reception system 10 to the demand prediction system 20 in response to the instruction, the control unit 219 of the managing computer 21 of the demand prediction system 20 acquires ID information “A3” as the ID information of the part for which demand prediction is to be performed, from the order reception system 10 (step S11). Then, the control unit 219 extracts order reception record data 2320 that indicates the ID information “A3” from the order reception data storage unit 232 (step S12). Thus, order reception record data 2320 for the year and months of order reception “March to June in 2005” are extracted.

Next, since transitional data 2310 that includes the ID information “A3” is stored in the transitional data storage unit 231 (step S13; YES), the control unit 219 extracts ID information “A1” and “A2” prior to the ID information “A3” from the pieces of ID information included in this transitional data 2310 (step S14). Then, the control unit 219 acquires order reception record data 2320 that indicate the extracted ID information “A1” and “A2” from the order reception record data storage unit 232 (step S15).

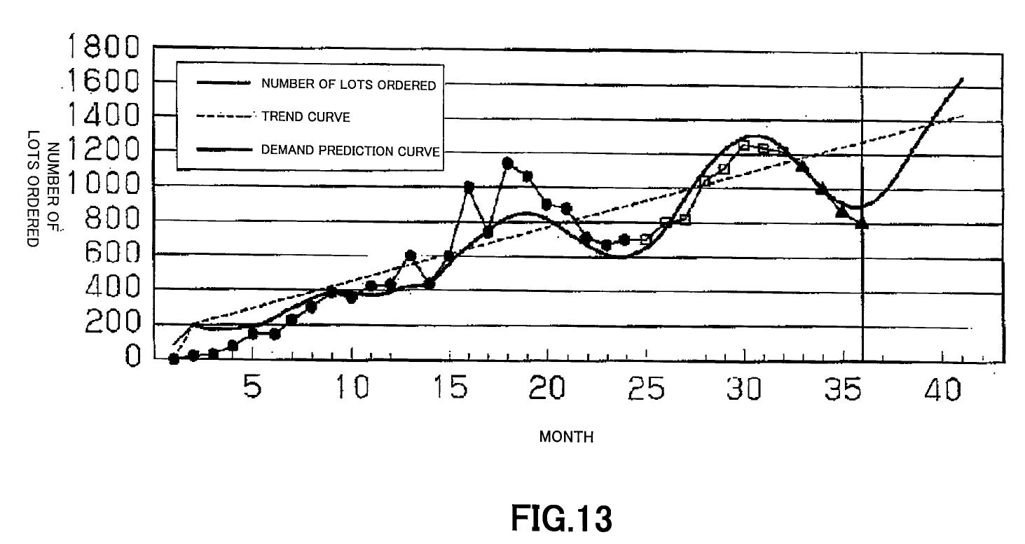

In this example, since there are no order reception record data 2320 (i.e., the order reception record data 2320 indicating the ID information “A1”, “A2”, and “A3”) that indicate the same year and month of order reception as each other among the plurality of order reception record data 2320 acquired at step S12 and step S15 (step S16; NO), generation of combined record data (step S17) is not to be performed. Then, the control unit 219 derives a demand prediction function by using the order reception record data 2320 acquired at step S12 and S15 (step S18). The curve of the demand prediction function derived here is shown in FIG. 13 by a solid line. The trend curve used for deriving the demand prediction function is also shown in FIG. 13 by a dotted line.

The control unit 219 calculates the numbers of lots (predicted values) in which the part having the ID information “A3” is to be ordered in the next month (July 2005) and in the month after that (August 2005) (step S19), and sends the calculation results to the order reception system 10 (step S20).

Then, the control unit 16 of the order reception system 10 displays the demand prediction results on the display unit 11 or prints them 12 by the printer 12. Thus, the demand prediction process is completed. As apparent from the above, when demand for the part having the part ID information “A3” is predicted, the records of not only this part but of the older-generation parts of this part that have the ID information “A1” and “A2” are also taken into consideration. Therefore, more accurate demand prediction is available and the user can place orders in appropriate quantities based on these predicted values.

As described above, the demand prediction apparatus 1 of the present embodiment performs accurate demand prediction even for a part that has been subjected to design change, because the prediction is based on the actual measurement values (numbers of lots ordered) of the part before subjected to design change. Therefore, it is possible to accurately predict demand for a product that has no or few order reception records.

Further, in deriving a demand prediction function, with the use of record data regarding a period that does not include the most recent period (evaluation period), provisional demand prediction functions are derived using a plurality of methods to calculate an error in the evaluation period for each provisional demand prediction function, and the provisional demand prediction function that has the smallest error is adopted as the function for predicting the demand. Therefore, the optimum demand prediction function for predicting demand for a part can be selected, and accurate demand prediction can be performed with the selected demand prediction function.

The above-described embodiment may be modified as follows.

In the above-described embodiment, in a case where a demand prediction function is to be derived (step S18), three methods, namely, accumulative second-order method, accumulative third-order method, and accumulative fourth-order method are used. The method for deriving the demand prediction function is not limited to these, but, for example, accumulative fifth-order method and accumulative sixth-order method may be used. Further, a demand prediction function may be derived with the use of a similar technique to the technique disclosed in Unexamined Japanese Patent Application KOKAI Publication No. 2004-234471. That is, in this case, after deriving a trend curve from the acquired order reception data, the control unit 219 derives a periodicity variable curve if the trend curve changes its periodicity. Then, the control unit 219 derives a demand prediction curve based on these trend curve and periodicity variable curve derived. If the trend curve has a fixed periodicity, a function generated by combining the trend function and the periodic function may be used as the demand prediction function. Further, in a case where a simpler demand prediction is requested, the control unit 219 may perform order reception prediction only by using a trend curve.

In the above-described embodiment, in the process for deriving a demand prediction function (step S18), the control unit 219 calculates en error of each provisional demand prediction function, and adopts the method with the smallest error calculated. However, the manner of deciding the method is not limited to this, but any manner may be used as long as the manner calculates predicted values in an evaluation period by using derived provisional demand prediction functions and adopts a method based on the difference between the predicted values and the actual measurement values in the evaluation period.

For example, a demand prediction function may be adopted based on a weighted error. Specifically, the storage unit 218 of the managing computer 21 pre-stores a weighting coefficient representing the weight of an error of a provisional demand prediction function, for each provisional demand prediction function. Then, in the process of deriving a demand prediction function (step S18), the method which has derived the provisional demand prediction function that has the smallest value among the error values calculated for the respective provisional demand prediction functions by adding the corresponding weighting coefficients, may be adopted as the method for deriving a demand prediction function.

With this manner, for example, it is possible to arrange that a method whose order is small should be adopted as frequently as possible, by setting a small weighting coefficient for the method whose order is small.

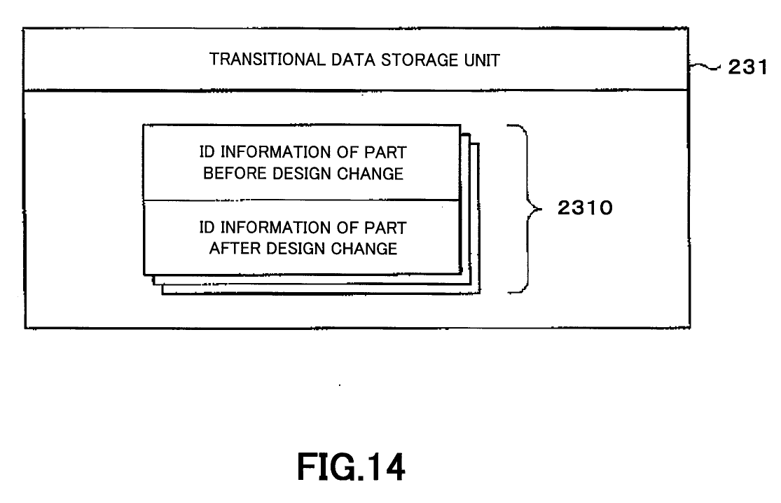

In the above-described embodiment, the transitional data 2310 has a data structure in which pieces of the ID information of a part subjected to design change are associated with one another in an order from the first one to the next ones. Instead of this, as shown in FIG. 14, transitional data 2130 which associates the ID information of a part before design change and the ID information of the part after design change may be used. That is, transitional data 2310 may have any data structure as long as the structure can associate the ID information of a part before design change and the ID information of the part after design change.

The following process may be followed in order to acquire ID information of an older-generation part by using the transitional data 2310 shown in FIG. 14.

First, the control unit 219 extracts transitional data 2310 that indicates the ID information of a part for which demand prediction is to be performed, as part ID information after design change. Then, the control unit 219 extracts transitional data 2310 that indicates the ID information of the part before design change which is written in the extracted transitional data 2310, as part ID information after design change. The control unit 219 keeps extracting transitional data 2310 that indicates the ID information of the part before design change which is written in the extracted transitional data 2310 as part ID information after design change, until no more such transitional data 2310 can be extracted. Then, the control unit 219 acquires the part ID information before design change written in every transitional data 2310 extracted, as the IDs of older-generation part.

In the above-described embodiment, after order reception record data 2320 of the part for which demand prediction is to be performed is acquired, the older-generation part of this part is specified and order reception record data 2320 of the order-generation part is acquired. However, the order in which order reception record data are acquired is not limited to this. For example, after the ID of the part for which demand prediction is to be performed is acquired, the older-generation part of this part for which demand prediction is to be performed may be specified and order reception record data 2320 of the part for which demand prediction is to be performed and order reception record data 2320 of the older-generation part may be acquired simultaneously.

In the above-described embodiment, the order reception record data 2320 of a part for which demand prediction is to be performed is acquired from the order reception record data storage unit 232, and with the use of this order reception record data 2320, a demand prediction function is derived. Instead, in a case where there is no order reception record data 2320 of the part for which demand prediction is to be performed, a demand prediction function may be derived by using order reception records of the older-generation part of this part. If the order reception record data 2320 of the part before design change is used, even in a case where there is no record of the part for which prediction is to be performed such as when the part for which the demand prediction is to be performed is to be put for sale on the market for the first time after the design change, demand prediction for this part can be accurately performed.

In the above-described embodiment, all the order reception record data 2320 for the part for which prediction is to be performed and for the older-generations of this part are used to derive a demand prediction function. Instead of this, a demand prediction function may be derived by using only order reception records for a predetermined period (e.g., the latest sixty months) that is immediately before the latest year and month of order reception. For example, in a case where demand prediction loses accuracy if older order reception records are taken into consideration, older order reception records (records for the time that is before a predetermined period immediately before a given reference time, which is recent) may be excluded in deriving a demand prediction function. This enables more accurate demand prediction values to be calculated.

In the above-described embodiment, order reception records of a part are registered on the monthly basis. This is not the only case, but, for example, order reception records of a once-in-each-some-months basis, weekly basis, or a once-in-each-some-weeks basis may be used.

In the above-described embodiment, demand prediction is performed for parts. However, the object for which demand prediction is performed is not limited to this, but may be other products as long as demand prediction methods can be applied to such products.

Further, in the case of a sequel product produced by partial change to a past product, if the past product can be recorded in association with the sequel, it is possible to predict demand for the product by utilizing the present invention based on the demand records of the past product. For example, the present invention can be applied to demand prediction for software often upgraded.

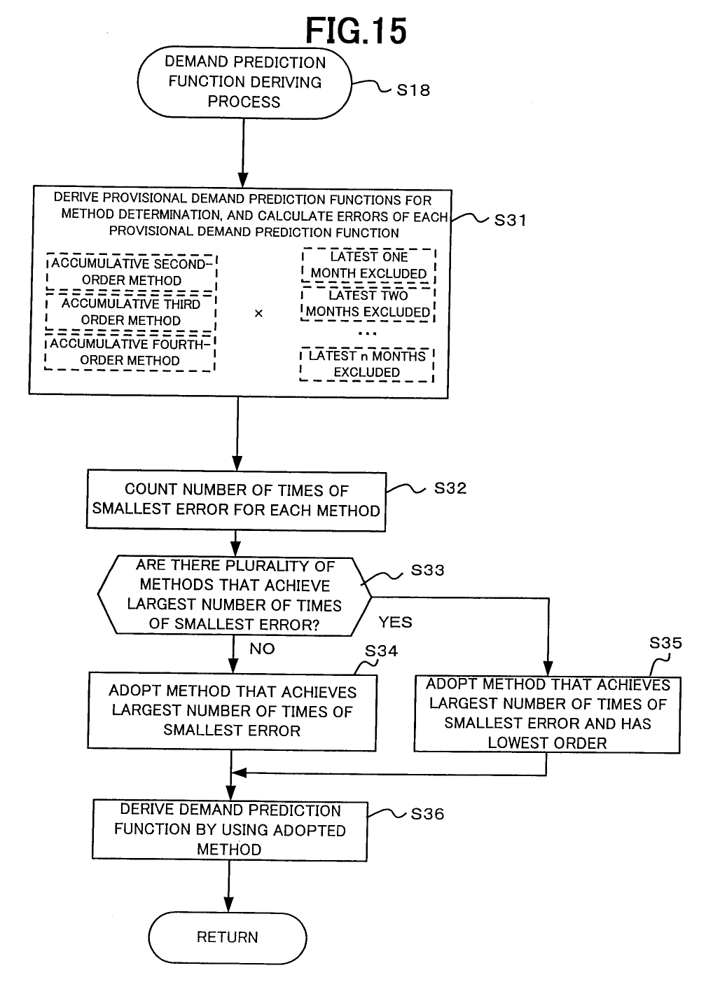

Further, the process of deriving a demand prediction function (step S18) may be performed by the procedures shown in FIG. 15.

First, the control unit 219 derives provisional demand prediction functions for deciding a demand prediction method, and calculates an error of each provisional demand prediction function (step S31). In this case, the control unit 219 first derives provisional demand prediction functions by using the respective accumulative second-order method, accumulative third-order method, and accumulative fourth-order method, and by using, among the acquired order reception record data 2320, those that are for the periods which do not include the latest one month to the latest n months respectively. That is, by varying the evaluation period which is immediately before the present time, the control unit 219 derives provisional demand prediction functions by using different methods, for each of the provisional function deriving periods which are different in length from one another. Then, by using the derived provisional demand prediction functions, the control unit 219 calculates a predicted value for the month that is not used for deriving the provisional demand prediction functions, and calculates the difference between the predicted value and the actual value of order reception recorded for the same month as the month for which this predicted value is calculated, as an error. In a case where there are a plurality of months that are not used for deriving provisional demand prediction functions, the sum of the differences, calculated for the respective months, between the predicted value and the actual value of order reception is used as the error.

This process (step S31) of calculating errors by deriving provisional demand prediction functions will be explained by raising a specific example. As a premise, the order reception records of the part for which a demand prediction function is to be derived are as shown in FIG. 8. That is, data for consecutive forty-five months immediately before the current month are recorded as the order reception record data 2320 regarding this part. Further, the provisional demand prediction functions for deciding the method are to be derived, by excluding the order reception record data 2320 for the latest one month to the latest five months. As the methods used for deriving provisional demand prediction functions, accumulative second-order method, accumulative third-order method, and accumulative fourth-order method will be used.

When the process of deriving a demand prediction function is started, the control unit 219 first derives provisional demand prediction functions by the respective methods, by using the order reception record data 2320 for the forty-four months except the latest one month. Then, the control unit 219 calculates predicted values for the forty-fifth month by using the respective provisional demand prediction functions derived, and calculates the differences between the predicted values and the actual measurement value as errors.

Next, the control unit 219 derives provisional demand prediction functions by the respective methods, by using the order reception record data 2320 for the forty-three months except the latest two months. Then, the control unit 219 calculates predicted values for the forty-fourth month and forty-fifth month by using the functions derived by the respective methods. The control unit 219 calculates the sum of the difference between the predicted value calculated for the forty-fourth month and the actual measurement value of the forty-fourth month and the difference between the predicted value calculated for the forty-fifth month and the actual measurement value of the forty-fifth month, as the error.

Likewise, the control unit 219 derives provisional demand prediction functions by the respective methods, by using the order reception record data 2320 for the forty-two months except the latest three months, and calculates predicted values for the forty-third month, forty-fourth month, and forty-fifth month by using the derived provisional demand prediction functions. Then, the control unit 219 calculates the differences between these predicted values and the actual measurement values of the forty-third to forty-fifth months respectively, and calculates the sum of these differences as errors.

Further, the control unit 219 derives provisional demand prediction functions by the respective methods, by using the order reception record data 2320 for the forty-one months except the latest four months, and calculates predicted values for the forty-second to forty-fifth months by using the derived provisional demand prediction functions. Then, the control unit 219 calculates the differences between these predicted values and the actual measurement values of the forty-second to forty-fifth months, and calculates the sum of these differences as errors.

Furthermore, the control unit 219 derives provisional demand prediction functions by the respective methods, by using the order reception record data 2320 for the forty months except the latest five months, and calculates predicted values for the forty-first to forty-fifth months by using the derived provisional demand prediction functions. Then, the control unit 219 calculates the differences between these predicted values and the actual measurement values of the forty-first to forty-fifth months, and calculates the sum of these differences as errors.

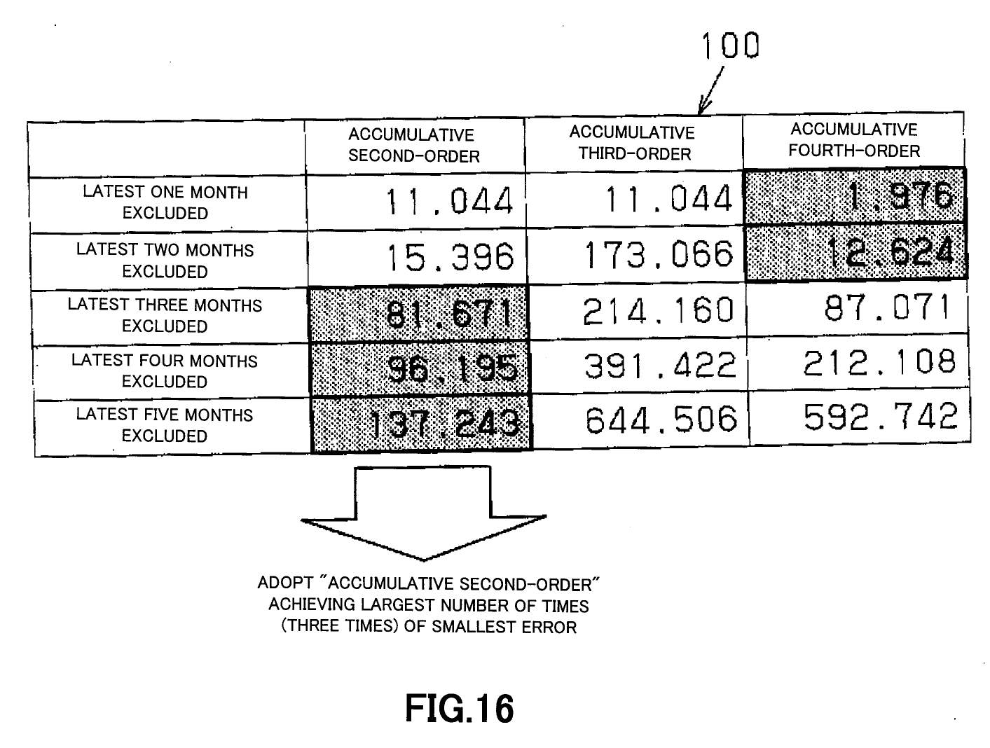

Through such a process, the errors of the respective provisional demand prediction functions derived by the respective methods for the respective provisional function deriving periods, which do not include the latest one month to the latest five months respectively, are calculated, as shown in a table 100 of FIG. 16.

Then, the control unit 219 obtains the number of times each method achieves the smallest error (step S32). Specifically, the control unit 219 specifies the method (method with the smallest error) which achieves the smallest error among the errors calculated for the respective methods, for the respective periods that do not include the latest one month to the latest five months respectively, and counts up the number of times (number of times of the smallest error) when each method is specified, for the respective methods.

For example, in a case where the errors are calculated as shown in the table 100 of FIG. 16, the control unit 219 specifies the method with the smallest error as the accumulative fourth-order method, for the case where the latest one month is excluded. The control unit 219 specifies the method with the smallest error as the accumulative fourth-order method, for the case where the latest two months are excluded. The control unit 219 specifies the method with the smallest error as the accumulative second-order method, for the case where the latest three months are excluded. The control unit 219 specifies the method with the smallest error as the accumulative second-order method, for the cases where the latest four months and the latest five months are excluded respectively. Then, the control unit 219 counts the number of times of the smallest error, as three for the accumulative second-order method, zero for the accumulative third-order method, and two for the accumulative fourth-order method.

Next, the control unit 219 determines whether or not there are a plurality of methods that achieve the largest number of times of the smallest error at the same time (step S33). In a case where it is determined that there are no plurality of methods that achieve the largest number of times of the smallest error at the same time (step S33; NO), the control unit 219 adopts the method that achieves the largest number of times of the smallest error (step S34) and performs the procedure of step S36. For example, in a case where the provisional demand prediction functions derived by the accumulative second-order method achieve the largest number of times of the smallest error as shown in FIG. 16, the control unit 219 adopts the accumulative second-order method.

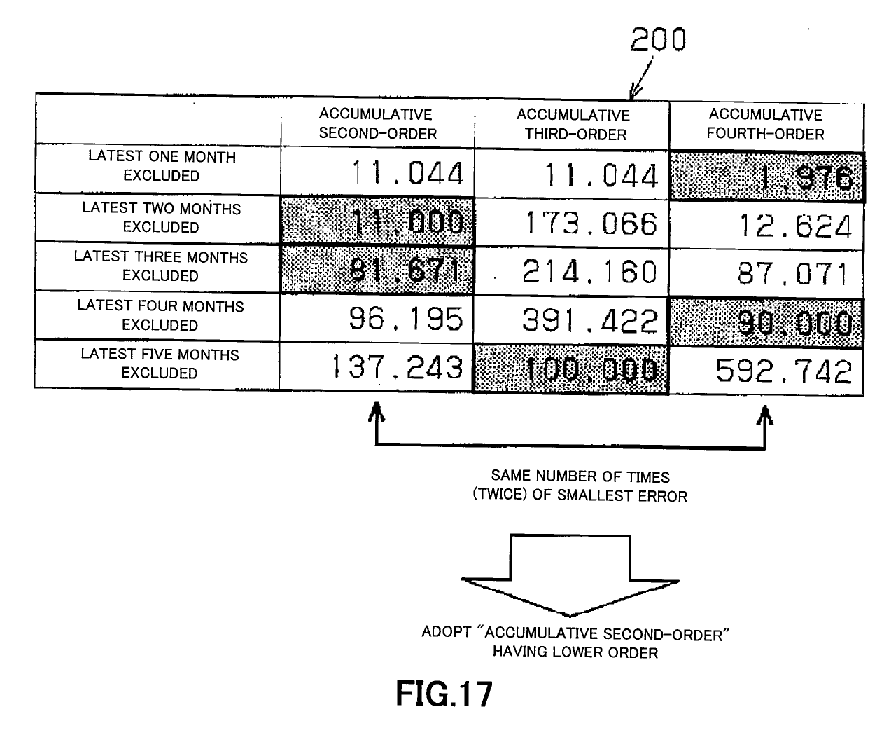

To the contrary, in a case where it is determined that there are a plurality of methods that achieve the largest number of times of the smallest error at the same time (step S33; YES), the control unit 219 adopts the method that achieves the largest number of times of the smallest error and has the lowest order (step S35), and performs the procedure of step S36. For example, in a case where, as shown in a table 200 of FIG. 17, the number of times of the smallest error achieved by the accumulative second-order method is two as equal to the accumulative fourth-order method, and larger than the number of times achieved by the accumulative third-order method, the accumulative second-order method is adopted as the method that achieves the largest number of times of the smallest error and has the lowest order.

At step S36, the control unit 219 derives a demand prediction function by using the adopted method. Specifically, the control unit 219 applies the method adopted at step S34 or S35 to all the acquired order reception record data 2320 to derive a demand prediction function.

For example, in a case where the accumulative second-order method is adopted as shown in FIG. 16 or FIG. 17, the control unit 219 derives a demand prediction function by using this accumulative second-order method and the order reception record data 2320 for up to the forty-fifth month.

Thus, the process of deriving a demand prediction function (steps S1 to S8) is completed.

As described above, since errors of provisional demand prediction functions are calculated for each of the different evaluation periods in the example shown in FIG. 15, selection of the method for a demand prediction function can be performed more accurately.

The process of deriving a demand prediction function shown in FIG. 15 described above can be modified as follows.

For example, it is possible to employ a scheme of further obtaining the sum of the errors between the actual measurement values and the predicted values calculated by each provisional demand prediction function derived by using the order reception records for the periods that do not include the latest one month to the latest five months respectively, and adopting the method that achieves the smallest sum.

In the process of deriving a demand prediction function shown in FIG. 15 described above, the managing computer 21 derives provisional demand prediction functions for deciding a method, by sequentially excluding the latest one month to the latest n months (step S31). Then, the managing computer 21 counts the number of times of the smallest error for the respective methods (step S32), and adopts the method that achieves the largest number of times of the smallest error (step S34 or step S35). Instead of this, it is possible to employ a scheme in which the control unit 219 calculates the errors of the respective methods for the evaluation periods that are immediately before the present time and adopts the method whose number of times of the smallest error first counts up to a predetermined number of times. Specifically, data regarding a deciding number of times, which decides a demand prediction method, is pre-stored in the storage unit 218. Then, the control unit 219 first specifies the method with the smallest error based on the provisional demand prediction functions for a provisional function deriving period which does not include the shortest evaluation period, and counts up the number of times of the smallest error for the specified method. Then, the control unit 219 compares this number of times of the smallest error with the deciding number of times. In a case where the number of times of the smallest error has not yet reached the deciding number of times, the control unit 219 sets an evaluation period that is the second shortest. Then, the control unit 219 specifies the method with the smallest error based on the provisional demand prediction functions for the period which does not include this evaluation period, counts up the number of times of the smallest error for the specified method, and compares this number of times of the smallest error with the deciding number of times. In this way, the control unit 219 counts the number of times of the smallest error by sequentially changing the evaluation period to a longer one until the number of times of the smallest error reaches the deciding number of times. Then, the control unit 219 uses the method whose number of times of the smallest error counted in this way reaches the deciding number of times first, as the method for deriving a demand prediction function. This makes it possible to specify a method with a fine fitting property, while making good use of the evaluation result acquired most lately.

### Second Embodiment

A demand prediction method and a demand prediction apparatus 2 according to the present embodiment predict demand for a part which is used for a new model of a product (hereinafter referred to as new model), which has no order reception records yet.

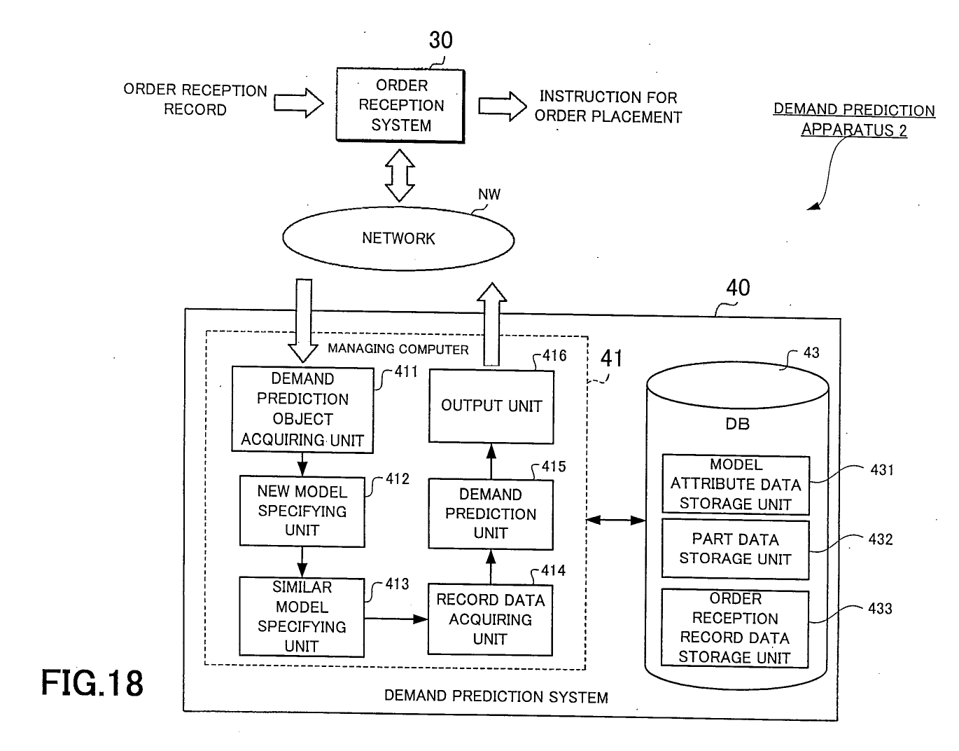

The demand prediction apparatus 2 according to the present embodiment comprises an order reception system 30 and a demand prediction system 40, as shown in FIG. 18.

The order reception system 30 has substantially the same structure and functions as those of the order reception system 10 explained in the first embodiment.

The order reception system 30 receives inputs of order reception records at a sales base, a servicing base, etc. The order reception system 30 places an order for a part to a manufacturing department or a purchase department, based on a demand prediction output from the demand prediction system 40.

As shown in FIG. 2, the order reception system 30 comprises a display unit 31, a printer 32, an operation unit 33, a communication unit 34, a control unit 35, and a storage unit 36. This structure is the same as the order reception system 10 of the first embodiment, and the function of each unit is also the same. Therefore, explanation for each unit will be omitted.

The order reception system 40 shown in FIG. 18 predicts demand for a part to be used for a new model, and comprises a managing computer 41 and a database 43 connected to the managing computer 41 through a network. The database 43 comprises a model attribute data storage unit 431, a part data storage unit 432, and an order reception record data storage unit 433.

Functionally, the managing computer 41 comprises a demand prediction object acquiring unit 411, a new model specifying unit 412, a similar model specifying unit 413, a record data acquiring unit 414, a demand prediction unit 415, and an output unit 416.

The demand prediction object acquiring unit 411 acquires ID information of a part to be used for a new model, which is to be the object of demand prediction, from the order reception system 30 through a network NW.

The new model specifying unit 412 determines whether or not data indicating a record of reception of an order for the part having the ID information acquired by the demand prediction object acquiring unit 411 is stored in the order reception record data storage unit 433. In a case where it is determined that no such data is stored, the new model specifying unit 412 specifies the model which uses this part, as a new model.

The similar model specifying unit 413 specifies a model (similar model) that is similar to the new model specified so by the new model specifying unit 412.

The record data acquiring unit 414 acquires record data regarding reception of a first order for a part used for the similar model, from the order reception record data storage unit 433.

The demand prediction unit 415 predicts demand for the part used for the new model for which demand prediction is performed, based on the order reception record data acquired by the record data acquiring unit 414.

The output unit 416 outputs data showing the prediction of demand for the part used for the new model obtained by the demand prediction unit 415 to the order reception system 30 through the network NW.

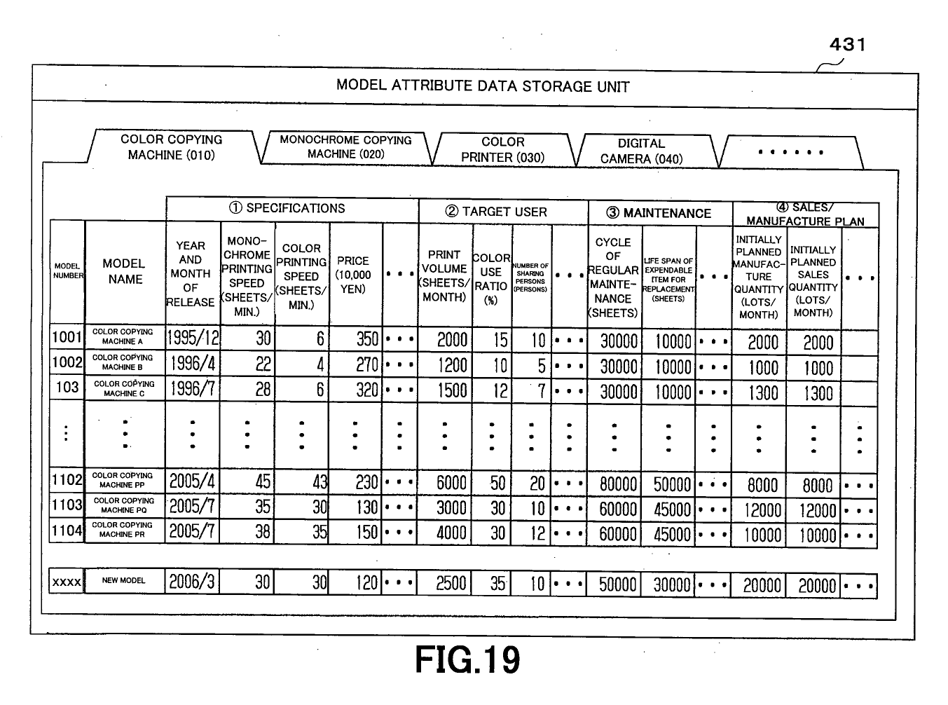

The model attribute data storage unit 431 stores model attribute data, for each model (model number) for which a part is used, as shown in FIG. 19. Model attribute data comprises data regarding model name, specifications, target user, maintenance, and sales/manufacture plan.

The specification data regards characteristics of the model. The specification data includes, for example, year and month of release, monochrome printing speed, color printing speed, and price.

The target user data regards assumed users of the model. The target user data includes, for example, the volume of print use per month (print volume), color printing use ratio, and a number of persons who shares a copying machine (number of sharing persons).

The maintenance data includes information regarding, for example, the cycle of regular maintenance, and the life span of expendable item for replacement.

The sales/manufacture plan data includes, for example, information regarding an initially planned manufacture quantity and an initially planned sales quantity. The initially planned manufacture quantity is the number of lots planned to be manufactured during one month after the first release. The initially planned sales quantity is the number of lots planned to be sold during one month after the first release. In the example shown in FIG. 19, the initially planned manufacture quantity and the initially planned sales quantity are set to the same quantity as each other.

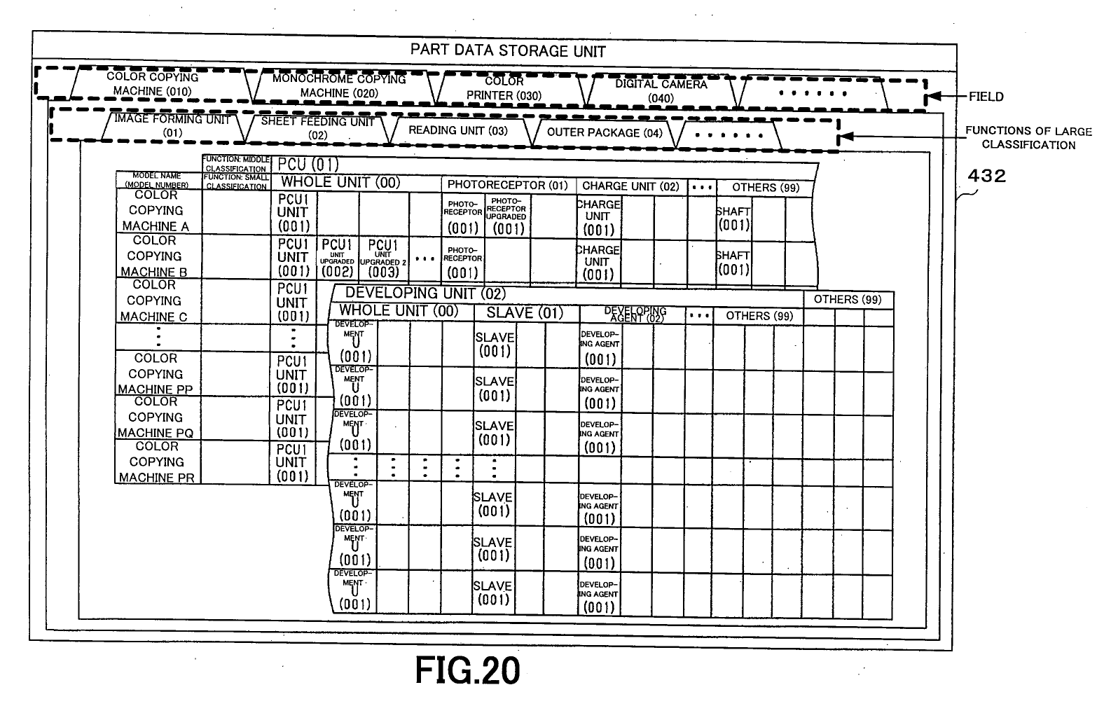

The part data storage unit 432 stores ID information for specifying a part, as shown in FIG. 20. The ID information is information constituted by combining numbers respectively specifying “field”, “model”, “functions of large classification”, “functions of middle classification”, “functions of small classification”, and “part” in this order.

“Field” includes a color copying machine, a monochrome copying machine, a color printer, a digital camera, etc., and is divided into “functions of large classification”. For example, a field “color copying machine” is divided into functions of large classification “image forming unit”, “sheet feeding unit”, “reading unit”, “outer package”, etc.

A “function of large classification” is divided into “functions of middle classification”. For example, a function of large classification “image forming unit” is divided into functions of middle classification “PCU”, “developing unit”, etc.

A “function of middle classification” is divided into “functions of small classification”. For example, a function of middle classification “developing unit” is divided into functions of small classification “whole unit”, “photoreceptor”, “charge unit”, etc.

A “function of small classification” is divided into parts. For example, a function of small classification “photoreceptor” is divided into parts “photoreceptor” and “photoreceptor upgraded”.

ID information of a part will be explained by raising a specific example. For example, assume that the number that specifies a field “color copying machine” is “010”, and the model number of a model “color copying machine A” is “1001”. The number that specifies a function of large classification “image forming unit” is “01”, and the number that specifies a function of middle classification “PCU” is “01”. Further, the number that specifies a function of small classification “whole unit” is “00”, and the number that specifies a part “PCU 1 unit” is “001”. In this case, the ID information of the part “PCU 1 unit” of a PCU used for the color copying machine A is expressed by “010-1001-01-01-00-001” (field-model number-function of large classification-function of middle classification-function of small classification-part number). Accordingly, the model for which a part is used, classifications of functions, part number can be specified from the ID information of a part.

The order reception record data storage unit 433 has a similar structure to that of the order reception record data storage unit 232 of the first embodiment shown in FIG. 5, and stores order reception record data 4330. Order reception record data 4330 is generated for each part and includes ID information of the part, information indicating the year and month when an order for the part is received, and information indicating the number of lots ordered. Order reception record data 4330 is generated by the managing computer 41 based on an order reception record per month output from the order reception system 30.

The demand prediction system 40 physically comprises the managing computer 41 that comprises a communication unit 417, a storage unit 418, a control unit 419, and a DB (Data Base) I/F (Inter Face) 420, and the database 43.

The communication unit 417 comprises communication devices such as an NIC (Network Interface Card), a router, a model, etc.

The storage unit 418 comprises a RAM, a ROM, a hard disk device, etc., and stores various information, operation programs of the control unit 419, etc.

The control unit 419 comprises a CPU or the like, and performs various calculations by executing the operation programs stored in the storage unit 418. Further, the control unit 419 exchanges data with the order reception system 30 through the communication unit 417.

The DB I/F 420 intermediates in the data exchange between the database 43 and the control unit 419.

The demand prediction object acquiring unit 411 and the output unit 416 shown in FIG. 18 physically comprise the control unit 419 and the communication unit 417.

The new model specifying unit 412, the similar model specifying unit 413, and the record data acquiring unit 414 physically comprise the control unit 419 and the DB I/F 420.

The demand prediction unit 415 physically comprises the control unit 419 and the storage unit 418.

Next, the procedures by which the demand prediction system 40 predicts demand for a part will be explained.

First, as a premise, an order reception staff inputs order reception data acquired from the daily order reception activities to the order reception system 30 from, for example, the operation unit 33. The control unit 36 of the order reception unit 30 stores the input data in the storage unit 35. The control unit 36 adds up the order reception record data stored in the storage unit 35 for each part, at a predetermined timing, for example, at midnight of the last day of a month, etc., and generates monthly order reception record data 4330 part by part. The control unit 36 supplies the generated order reception record data 4330 from the communication unit 34 to the demand prediction system 40 through the network NW. The control unit 419 of the demand prediction system 40 receives the data through the communication unit 417, and stores the data in the order reception record data storage unit 433 in the database 43 through the DB I/F 420.

It is assumed that data indicating attributes of models (including new models) are pre-stored in the model attribute data storage unit 431.

It is further assumed that ID information of each part is pre-stored in the part data storage unit 432.

Next, when it becomes necessary to predict demand for a given part, a user operates the operation unit 33 of the order reception system 30 and inputs an instruction for performing demand prediction for the part which is to be used for a new model and ID information that specifies the objective part. In response to the input instruction, the control unit 36 sends a demand prediction start command from the communication unit 34 to the demand prediction system 40 through the network NW.

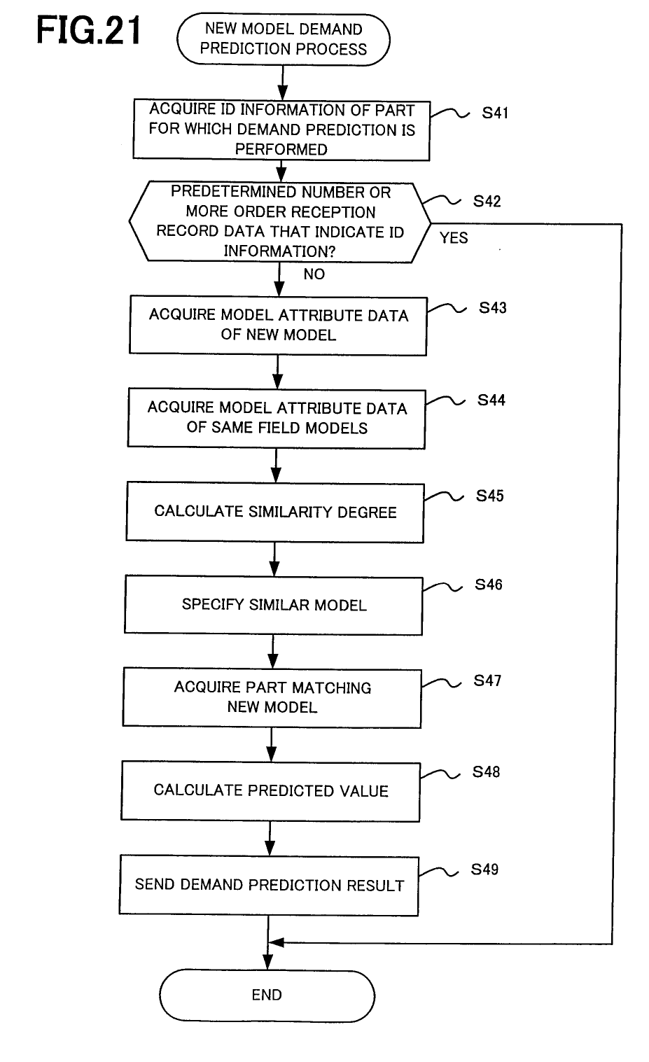

The control unit 419 of the demand prediction system 40 receives the demand prediction start command through the communication unit 417. In response to the demand prediction start command, the control unit 419 starts a new model demand prediction process shown in FIG. 21, if possible.

When the process is started, the control unit 419 requests the ID information of the part for which demand prediction is to be performed, from the order reception system 30 through the network NW. In response to this request, the order reception system 30 sends the input ID information to the demand prediction system 40. The control unit 419 of the demand prediction system 40 acquires this ID information through the communication unit 417 (step S41). Thus, the function of the demand prediction object acquiring unit 411 is realized.

Next, the control unit 419 determines whether or not the a predetermined number or more order reception record data 4330 that indicate(s) the ID information acquired at step S41 is/are stored in the order reception record data 433 (step S42).

In a case where it is determined that the predetermined number or more such data is/are stored (step S42; YES), which means that the model for which demand prediction is performed, is not a new model, the new model demand prediction process is terminated.

In a case where it is determined that no predetermined number or more such data is/are stored (step S42: NO), which means that the part having the ID information acquired at step S41 is a part used for a new model, the process proceeds to step S43.

At step S43, the control unit 419 acquires model attribute data regarding the new model (step S43).

Specifically, the control unit 419 first extracts the model number included in the ID information acquired at step S41.

For example, in a case where the ID information of the new model is “010-1001-01-01-00-001” (field-model number-function of large classification-function of middle classification-function of small classification-part number), a model number “1001” is extracted. Then, the control unit 419 acquires model attribute data regarding the model having the extracted model number from the model attribute data storage unit 431.

Next, the control unit 419 acquires model attribute data regarding a model (same field model) that is in the same field as the new model (step S44).

Specifically, the control unit 419 first extracts the field number included in the ID information acquired at step S41. For example, in a case where the ID information of the new model is “010-1001-01-01-00-001” (field-model number-function of large classification-function of middle classification-function of small classification-part number), a field number “010” is extracted. Then, the control unit 419 extracts all pieces of ID information that do not include the model number of the new model, among the pieces of part ID information that include the extracted field number, from the part data storage unit 432, and extracts the model numbers included in the extracted pieces of ID information.

Then, the control unit 419 acquires the model attribute data regarding the models that have that extracted model numbers from the model attribute data storage unit 431, as model attribute data of same field models

For example, in a case where the ID information of the new model acquired at step S41 is an ID that specifies a model “color copying machine” and such information as shown in FIG. 19 is stored in the model attribute data storage unit 431, the model attribute data regarding color copying machines A, B, C, . . . , PP, PQ, and PR are acquired as the model attribute data of same field models. Here, information regarding specifications, target user, and maintenance is acquired as the model attribute data.

Then, the control unit 419 calculates the similarity degree between the new model whose mode attribute data is acquired at step S43 and the same field models whose model attribute data are acquired at step S44 (step S45). Specifically, the control unit 419 calculates Euclidean distances d₁, d₂, . . . , dₙ between the model attribute data of the new model and that of the same field models, where each data included in the model attribute data is an explaining variable, and use the distances as similarity degrees.

“n” is a number that indicates the number of same field models. The Euclidean distance d₁ indicates the Euclidean distance between the new model and the first same field model, the Euclidean distance d₂ indicates the Euclidean distance between the new model and the second same field model, and the Euclidean distance dₙ indicates the Euclidean distance between the new model and the n-th same field model. That is, the same number of Euclidean distances (i.e., similarity degrees) as the number of same field models are calculated.

The procedures by which Euclidean distances are calculated will be explained below.

First, the control unit 419 normalizes each data included in the model attribute data, so that all the data can be used under the same evaluation system. Specifically, the control unit 419 converts the values represented by the respective data included in the model attribute data, such that their average becomes “0” and their standard deviation becomes “1”. This makes it possible to evaluate the respective explaining variables on an equal base, even if the respective data included in the model attribute data and used as the explaining variables are indicated in different units (number of sheets, time, price, etc.)

Next, the control unit 419 calculates the Euclidean distance dₙ between the new model and the n-th same field model, by using the explaining variables normalized in this manner.

The Euclidean distance dₙ is calculated by the following equation (1).
dₙ=\sqrt{(X₁ₙ−X_{1new})+(X₂ₙX_{2new})+ . . . +(Xₘₙ−X_{mnew})} (1)

In the equation (1), X₁ₙ, X₂ₙ, . . . , Xₘₙ are values obtained by normalizing the values of the respective data included in the model attribute data of the n-th same field model. X_{1new}, X_{2new}, . . . , X_{mnew} are values obtained by normalizing the values of the respective data included in the model attribute data of the new model. Here, “m” is a numeral indicating the number of explaining variables.

For example, where m=9, and normalized values representing monochrome printing speed, color printing speed, year and month of release, price, print volume, color printing use ratio, number of sharing persons, cycle of regular maintenance, and life span of expendable item for replacement of both of the new model and the n-th same field model are assigned to X_{1new} and X₁ₙ, X_{2new} and X₂ₙ, X_{9new} and X₉ₙ, the Euclidean distance dₙ is calculated.

Then, the control unit 419 likewise calculates the Euclidean distances (d₁, d₂, . . . , dₙ₋₁) between the new model and the other same field distances, thereby obtaining the Euclidean distances (similarity degrees).

Next, the control unit 419 specifies the model (similar model) that is the most similar to the new model, based on the similarity degrees calculated at step S45 (step S46). Specifically, the control unit 419 specifies the same field model that is used for obtaining the smallest Euclidean distance among the Euclidean distances calculated at step S45, as the similar model.

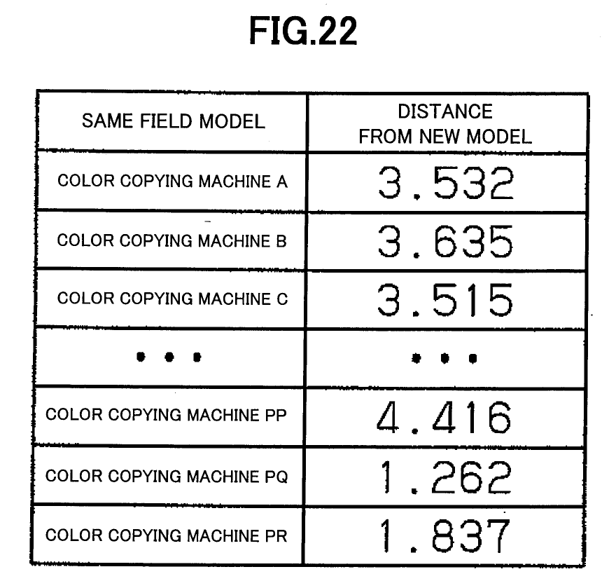

For example, in a case where the Euclidean distances are calculated as shown in a table of FIG. 22, the control unit 419 specifies a model “color copying machine PQ” as the similar model, as the Euclidean distance between the model “color copying machine PQ” and the new model is the smallest.

Next, the control unit 419 acquires the ID information of a part that matches the new model, among the parts used for the specified similar model (step S47).

Specifically, the control unit 419 extracts the number (hereinafter referred to as matching part specifying number) that indicates function of large classification, function of middle classification, function of small classification, and part from the ID information of the part used for the new model acquired at step S41. Then, the control unit 419 extracts the ID information of a part used for the similar model specified at step S46 from the part data storage unit 432. In a case where the extracted ID information includes the matching part specifying number, the control unit 419 acquires the ID information of this part, as the part that matches the new model.

For example, in a case where the ID information acquired at step S41 is “010-1001-01-01-00-001” (field-model number-function of large classification-function of middle classification-function of small classification-part number), the matching part specifying number is extracted as “01-01-00-001” (function of large classification-function of middle classification-function of small classification-part number). Then, in a case where the ID information of a part used for the similar model is “010-1002-01-01-00-001”, the control unit 419 acquires this ID information as ID information of a part matching the new model, because (function of large classification-function of middle classification-function of small classification-part number) of this ID information coincides with the matching part specifying number.

Then, the control unit 419 calculates a predicted value of demand for the part (step S48).

Specifically, the control unit 419 first acquires data regarding the initially planned sales quantity of the new model and of the similar model, from the model attribute data storage unit 431. Next, the control unit 419 calculates the rate of the initially planned sales quantity of the new model to the initially planned sales quantity of the similar model (hereinafter referred to as rate of planned sales quantities) by using the acquire data regarding the initially planned sales quantity. Then, the control unit 419 acquires an initial order reception record of the part (matching part) of the similar model, which matches the new model and whose ID information is acquired at step S47, from the order reception record data storage unit 433. The number of lots ordered that is written in order reception record data 4330 that indicates the oldest year and month of order reception, among the order reception record data 4330 that are stored in the order reception record data storage unit 433 and indicate the ID information of the matching part, may be acquired as the initial order reception record of the matching part. Then, the control unit 419 multiplies the acquired initial order reception record by the calculated rate of planned sales quantities, and obtains this product as the predicted value of demand.

That is, the predicted value of demand for the part is calculated by the following equation (2).
Predicted value of demand=initial order reception record of the part of the similar model that matches the new model×(initially planned sales quantity of the new model)/(initially planned sales quantity of the similar model) (2)
Next, the control unit 419 sends the predicted value of demand calculated at step S48 to the order reception system 30 through the network NW (step S49).

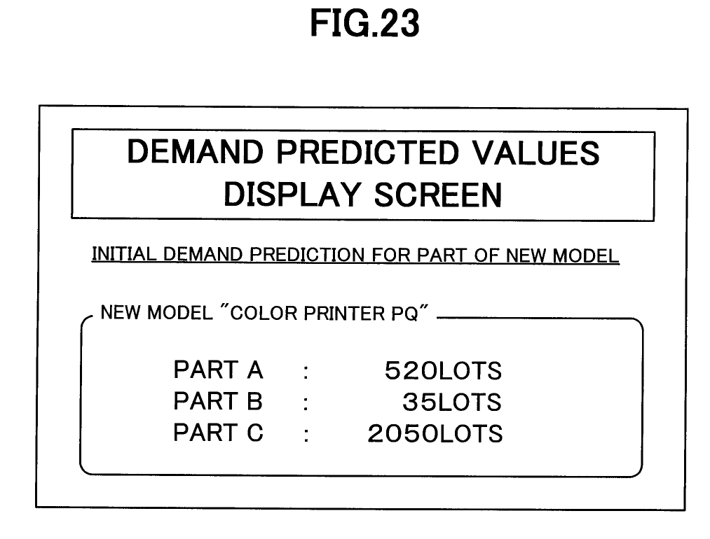

Then, the control unit 36 of the order reception system 30 displays the received predicted value on the display unit 31, as shown in FIG. 23. The control unit 36 prints the received predicted value from the printer 32. Thus, the demand prediction process is completed.

The user can instruct order placement for the part used for the new model in appropriate lots, based on the prediction result displayed or printed by the order reception system 30.

As described above, even if the part to be predicted is a part used for a new model, which has no order reception records in the past, the demand prediction apparatus 2 according to the present embodiment predicts demand for this part based on the order reception records of a part used for a similar model that is similar to the new model. Therefore, it is possible to predict demand for a new product accurately.

The above-described embodiment may be modified as follows.

In the above-described embodiment, model attribute data regarding specifications, target user, and maintenance are used as explaining variables for calculating the similarity degree. The data used for calculating a similarity degree are not limited to these. For example, only some of the model attributes regarding specifications, target user, and maintenance may be used. Further, in a case where models in the same field have different number of data items included in their model attribute data, only the common items may be used as explaining variables in calculating the similarity degree.

In the above-described embodiment, the Euclidean distances between a new model and existing models are calculated and used for specifying a similar existing model. The method for specifying a similar existing model that is similar to a new model is not limited to this. For example, the explaining variables may be weighted according to their properties to calculate the Euclidean distances.

Specifically, the control unit 419 finds weights W₁, W₂, . . . , Wₘ for determining similarity degrees, which correspond to the model attribute data respectively, based on an empirical rule, for the respective explaining variables, and stores them in the storage unit 418. Then, the control unit 419 calculates a weighted Euclidean distance dₙ by the equation (3) shown below.
dₙ=\sqrt{W₁(X₁ₙ−X_{1new})+W₂(X₂ₙ−X_{2new})+ . . . +Wₘ(Xₘₙ−X_{mnew})} (3)

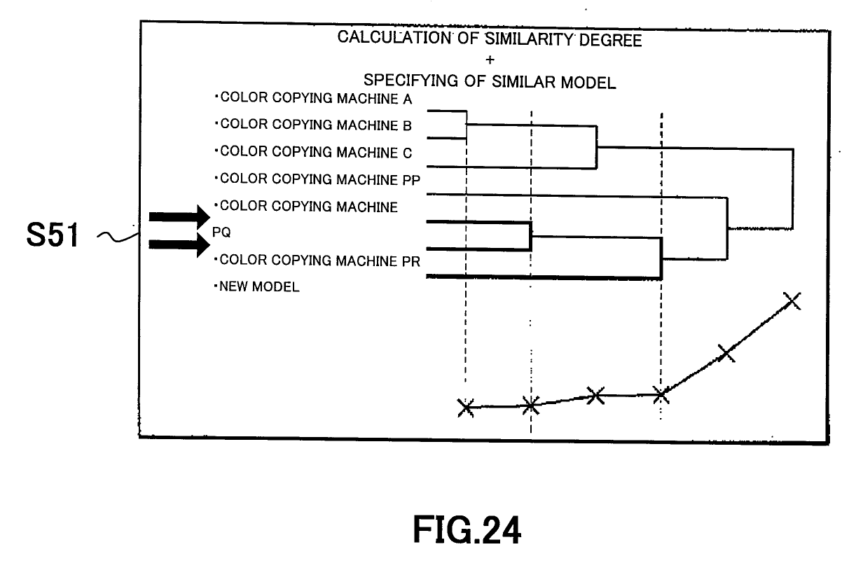

Further, instead of performing the procedures of step S45 and step S46, the control unit 419 may perform the procedure of step S51 shown in FIG. 24 in which cluster analysis is used to calculate calibrated Euclidean distances to clusters and specify a similar existing model based on a similar cluster. That is, the control unit 419 performs a similar main-product model specifying process of performing cluster analysis by using attribute data as explaining variables, and specifying a similar model from a smallest cluster that includes the new model.

Specifically, the control unit 419 generates hierarchical clusters by using the attribute data of same field models and the new model, and specifies a smallest cluster that includes the new model. Then, the control unit 419 specifies a similar model out of a same field model cluster which is included in this cluster. For example, in a case where hierarchical clusters are generated as shown in FIG. 24, a same field model cluster made up of color copying machines PQ and PR is included in a smallest cluster that includes the new model. Therefore, these color copying machines PQ and PR are specified as similar models.

In the above-described embodiment, in calculating a predicted value of demand for a part (step S48), the control unit 419 calculates a rate of the initially planned sales quantity of the new model to the initially planned sales quantity of the similar model, and multiplies this value by the initial order reception record of a part matching the new model acquired at step S47, thereby calculating a predicted value of demand. Calculation of a predicted value of demand for a part of a new model is not limited to this, but any other calculation formula may be used as long as it can predict demand by using the initially planned sales quantity of the matching part of the similar model.

For example, in a case where two ore more similar models are specified, the managing computer 41 may acquire the order reception record data of matching parts of all of these similar models. Then, the control unit 419 may multiply each of the acquired order reception record data by a rate of planned sales quantities of these similar models, and obtain the average of these products as the predicted value of demand for the part. In a case where similar models have different degrees of similarity to the new model, the similar models may be weighted according to their similarity degrees in calculating a predicted value of demand for a part.

In the above-described embodiment, demand prediction is for a part. The object of demand prediction is not limited to this. For example, demand prediction may be applied as long as there exists such a part product as a product attachable and detachable to/from a new product, which part product is used for a new model of a main product whose similar product, which is similar to this main product includes a part product matching the main product.

As a recording medium for storing a program and data for realizing the functions of the demand prediction apparatus of the present invention, specifically, a CD-ROM (-R/-RW), a magneto-optical disk, a DVD-ROM, an FD, a flash memory, a memory card, a memory stick, and ROMs and RAMs, etc. of any other types may be used. A demand prediction apparatus which performs the above-described processes may be constructed by distributing the recording medium and installing the program, etc. on a computer. Further, the program, etc. may be stored in a disk device belonging to a server apparatus existing on a network such as the Internet, etc., so that, for example, the program may be embedded on a carrier wave and downloaded to a computer.

In a case where an OS bears part of the above-described functions or in a case where an OS and an application realizes the functions in cooperation, those parts that are not borne by the OS may only be stored and distributed in a medium, or embedded on a carrier wave to be downloaded on a computer.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2006-114818 filed on Apr. 18, 2006, Japanese Patent Application No. 2006-121155 filed on Apr. 25, 2006, and Japanese Patent Application No. 2006-121156 filed on Apr. 25, 2006, and including specification, claims, drawings and summary. The disclosures of the above Japanese Patent Applications are incorporated herein by reference in their entireties.

What is claimed is:

1. A demand prediction apparatus connected to an order reception record data storage unit for storing an order reception record of a product, and an association information storage unit for storing association information for associating products with each other, comprising:
a product identification information acquiring unit which acquires identification information of a product, for which demand prediction is to be performed;
an associated product specifying unit which specifies at least one associated product which is associated with the product having the identification information acquired by said product identification information acquiring unit, based on the association information stored in said association information storage unit, so that demand for the product is predicted;
a predicted value calculating unit which acquires an order reception record of the associated product specified by said associated product specifying unit from said order reception record data storage unit, and calculates a predicted value of the demand based on the acquired order reception record; and
a predicted value output unit which output the predicted value calculated by said predicted value calculating unit.

2. The demand prediction apparatus according to 1,
wherein said association information storage unit stores product history information indicating from what product a product is changed, as the association information,
said associated product specifying unit
comprises a product history information acquiring unit which acquires product history information regarding a product having identification information acquired by said product identification information acquiring unit from said association information storage unit, and
specifies a product which is indicated by the product history information acquired by said product history information acquiring unit and from which the product having the identification information acquired by said product identification information acquiring unit has been changed, as an associated product, and
said predicted value calculating unit
comprises: a record acquiring unit which acquires an order reception record of the associated product specified by said associated product specifying unit and an order reception record of the product having the identification information acquired by said product identification information acquiring unit from said order reception record data storage unit; and
a demand prediction function deriving unit which derives a demand prediction function for predicting demand for the product, by using the order reception records acquired by said record acquiring unit, and
calculates a predicted value of the demand for the product, by using the demand prediction function derived by said demand prediction function deriving unit.

3. The demand prediction apparatus according to claim 2,
wherein said association information storage unit stores, as the product history information, identification information of each of past products from one of which to another of which a product has been changed, in association with identification information of the product, and
said product history information acquiring unit acquires all pieces of ID information that are associated with identification information acquired by said product identification information acquiring unit, from said association information storage unit, as product history information.

4. The demand prediction apparatus according to claim 2,
wherein said association information storage unit stores, in association with identification information of a product, identification information of at least one product, which is in an older generation than the product,
said product history information acquiring unit
comprises a unit which performs a process of acquiring identification information associated with identification information acquired by said product identification information acquiring unit based on the association information stored in said association information storage unit, and an older generation product acquiring process of acquiring identification information of a product which is in an older generation than a product having the identification information thusly acquired, based on the association information stored in said association information storage unit, and
repeats said older generation product acquiring process until it is no more possible to acquire identification of any product that is in an order generation, and acquires all pieces of acquired identification information, as product history information.

5. The demand prediction apparatus according to claim 2,
wherein in a case where order reception records of a plurality of products acquired by said record acquiring unit include order reception records of a same period, said record acquiring unit acquires a record obtained by adding these order reception records of the same period, as an order reception record of this period.

6. The demand prediction apparatus according to claim 1,
wherein said association information storage unit stores information that associates a product with an apparatus that uses this product, as association information,
said demand prediction apparatus further comprises an apparatus attribute data storage unit which stores, for each apparatus, attribute data regarding the apparatus,
said associated product specifying unit
comprises: an apparatus specifying unit which specifies an apparatus that uses a product having identification information acquired by said product identification information acquiring unit, based on the association information stored in said association information storage unit; and
a similar apparatus specifying unit which specifies a similar apparatus which is similar to the apparatus specified by said apparatus specifying unit, based on the attribute data stored in said apparatus attribute data storage unit, and
specifies a product used by the similar apparatus specified by said similar apparatus specifying unit based on the association information stored in said association information storage unit, and specifies this specified product as an associated product in a case where identification information of this specified product coincides with the identification information acquired by said product identification information acquiring unit, and
said predicted value calculating unit
comprises a record acquiring unit which acquires an initial order reception record of the associated product specified by said associated product specifying unit from said order reception record data storage unit, and
calculates a predicted value of demand for the product having the identification information acquired by said product identification information, by using the initial order reception record acquired by said record acquiring unit.

7. The demand prediction apparatus according to claim 6,
wherein the attribute data includes data regarding an initially planned sales quantity of an apparatus, and
said predicted value calculating unit
comprises an initially planned sales quantity acquiring unit which acquires an initially planned sales quantity of each of the apparatus specified by said apparatus specifying unit and the similar apparatus, from the attribute data stored in said apparatus attribute data storage unit, and
calculates a value obtained by multiplying the initial order reception record acquired by said record acquiring unit by a rate of the initially planned sales quantity of the apparatus specified by said apparatus specifying unit to the initially planned sales quantity of the similar apparatus, as a predicted value.

8. The demand prediction apparatus according to claim 6,
wherein said similar apparatus specifying unit calculates a Euclidean distance between the apparatus specified by said apparatus specifying unit and each of a plurality of other apparatuses by using the attribute data of both the apparatuses as explaining variables, and specifies any of the plurality of other apparatuses, whose calculated Euclidean distance is smallest, as the similar apparatus.

9. The demand prediction apparatus according to claim 8,
wherein said similar apparatus specifying unit normalizes the explaining variables, and calculates the Euclidean distance by using the normalized explaining variables.

10. The demand prediction apparatus according to claim 6,
wherein said similar apparatus specifying unit performs cluster analysis between the apparatus specified by said apparatus specifying unit and each of a plurality of other apparatuses by using the attribute data of both the apparatuses as explaining variables, and specifies any of the plurality of other apparatuses that is included in a smallest cluster that includes the apparatus specified by said apparatus specifying unit, as the similar apparatus.

11. The demand prediction apparatus according to claim 8,
wherein the attribute data includes data regarding specifications of an apparatus, data regarding an assumed user of the apparatus, and data regarding maintenance of the apparatus, and
said similar apparatus specifying unit uses at least one of the data regarding specification of an apparatus, the data regarding an assumed user of the apparatus, and the data regarding maintenance of the apparatus, which are included in the attribute data, as an explaining variable.

12. A demand prediction apparatus connected to an order reception record data storage unit for storing an order reception record of a product, comprising:
a product identification information acquiring unit which acquires identification information of a product for which demand prediction is to be performed;
an order reception record acquiring unit which acquires order reception records of the product having the identification information acquired by said product identification information acquiring unit from said order reception record data storage unit;
a provisional demand prediction function deriving unit which, by using a plurality of methods, derives provisional demand prediction functions that are fitted to those order reception records, among the order reception records acquired by said order reception record acquiring unit, that are dated in a provisional function deriving period which does not include a predetermined evaluation period which is immediately before a present time,
a method specifying unit which calculates predicted values of order reception records of the evaluation period by using the provisional demand prediction functions derived by said provisional demand prediction function deriving unit, and specifies a method for deriving a demand prediction function based on the calculated predicted values and order reception records of the evaluation period stored in said order reception record data storage unit;
a demand prediction function deriving unit which derives a demand prediction function which is fitted to the order reception records acquired by said order reception record acquiring unit, by using the method specified by said method specifying unit;
a predicted value calculating unit which calculate a predicted value of demand for a product by using the demand prediction function derived by said demand prediction function deriving unit; and
a predicted value output unit which outputs the predicted value calculated by said predicted value calculating unit.

13. The demand prediction apparatus according to claim 12,
wherein said method specifying unit calculates, for each of a plurality of provisional demand prediction functions derived by said provisional demand prediction function deriving unit, a difference between the predicted value of the evaluation period calculated by using the provisional demand prediction function and the order reception record of the evaluation period stored in the order reception record data storage unit, specifies a provisional demand prediction function whose calculated difference is smallest, and specifies a method used for deriving the specified provisional demand prediction function as a method for deriving a demand prediction function.

14. The demand prediction apparatus according to claim 12,
wherein said provisional demand prediction function deriving unit derives the provisional demand prediction functions by using a plurality of methods, for each of a plurality of provisional function deriving periods each of which does not include an evaluation period different in length from other evaluation periods which are not included in the others of the plurality of provisional function deriving periods respectively, and
said method specifying unit performs a process of calculating, for each of the provisional function deriving periods, a difference between a predicted value of a corresponding one of the evaluation periods calculated by using each of the provisional demand prediction functions derived for the provisional function deriving period concerned and the order reception record of that evaluation period, and counting up a score of the method that derives the provisional demand prediction function whose calculated difference is smallest, for each of the provisional function deriving periods, and specifies the method whose score is counted up most often, as a method for deriving a demand prediction function.

15. The demand prediction apparatus according to claim 13,
wherein in a case where there are a plurality of provisional demand prediction functions whose calculated differences between a predicted value calculated by using each of these provisional demand prediction functions and the order reception record acquired from said order reception record data storage unit are smallest at a same time, said method specifying unit specifies a method whose order is lowest of the methods used for deriving these plurality of provisional demand prediction functions, as a method for deriving a demand prediction function.

16. The demand prediction apparatus according to claim 14,
wherein in a case where there is a plurality of methods whose scores are counted up most often at a same time, said method specifying unit specifies a method whose order is lowest of these methods, as a method for deriving a demand prediction function.

17. A demand prediction method for a demand prediction apparatus connected to an order reception record data storage unit for storing an order reception record of a product and an association information storage unit for storing association information for associating products with each other, said method comprising:
acquiring identification information of a product for which demand prediction is to be performed;
specifying at least one associated product which is associated with the product having the acquired identification information based on the association information stored in said association information storage unit, so that demand prediction for the product having the acquired identification information is performed;
acquiring an order reception record of the specified associated product from said order reception record data storage unit, and calculating a predicted value of demand based on the acquired order reception record; and
outputting the calculated predicted value.

18. A demand prediction method for a demand prediction apparatus connected to an order reception record data storage unit for storing an order reception record of a product, said method comprising:
acquiring identification information of a product for which demand prediction is to be performed;
acquiring order reception records of the product having the acquired identification information from said order reception record data storage unit;
by using a plurality of methods, deriving provisional demand prediction functions which are fitted to those order reception records, among the acquired order reception records, that are dated in a provisional function deriving period which does not include a predetermined evaluation period which is immediately before a present time;
calculating a predicted value of the order reception record of the evaluation period by using each of the derived provisional demand prediction functions, and specifying a method for deriving a demand prediction function based on the calculated predicted values and the order reception record of the evaluation period stored in said order reception record data storage unit;
deriving a demand prediction function which is fitted to the order reception records, by using the specified method;
calculating a predicted value of demand for the product by using the derived demand prediction function; and
outputting the calculated predicted value.

19. A computer-readable recording medium storing a program for controlling a computer connected to an order reception record data storage unit for storing an order reception record of a product and an association information storage unit for storing association information for associating products with each other, to function as:
a product identification information acquiring unit which acquires identification information of a product, for which demand prediction is to be performed;
an associated product specifying unit which specifies at least one associated product which is associated with the product having the identification information acquired by said product identification information acquiring unit, based on the association information stored in said association information storage unit, so that demand for the product is predicted;
a predicted value calculating unit which acquires an order reception record of the associated product specified by said associated product specifying unit from said order reception record data storage unit, and calculates a predicted value of the demand based on the acquired order reception record; and
a predicted value output unit which outputs the predicted value calculated by said predicted value calculating unit.

20. A computer-readable recording medium storing a program for controlling a computer connected to an order reception record data storage unit for storing an order reception record of a product, to function as:
a product identification information acquiring unit which acquires identification information of a product for which demand prediction is to be performed;
an order reception record acquiring unit which acquires order reception records of the product having the identification information acquired by said product identification information acquiring unit from said order reception record data storage unit;
a provisional demand prediction function deriving unit which, by using a plurality of methods, derives provisional demand prediction functions that are fitted to those order reception records, among the order reception records acquired by said order reception record acquiring unit, that are dated in a provisional function deriving period which does not include a predetermined evaluation period which is immediately before a present time,
a method specifying unit which calculates predicted values of order reception records of the evaluation period by using the provisional demand prediction functions derived by said provisional demand prediction function deriving unit, and specifies a method for deriving a demand prediction function based on the calculated predicted values and order reception records of the evaluation period stored in said order reception record data storage unit;
a demand prediction function deriving unit which derives a demand prediction function which is fitted to the order reception records acquired by said order reception record acquiring unit, by using the method specified by said method specifying unit;
a predicted value calculating unit which calculates a predicted value of demand for the product by using the demand prediction function derived by said demand prediction function deriving unit; and
a predicted value output unit which outputs the predicted value calculated by said predicted value calculating unit.
